(19) United States
(12) Patent Application Publication
(10) Pub. No.: US 2015/0016267 A1
(43) Pub. Date: Jan. 15, 2015

(54) MODULAR ARRANGEMENT DECISION DEVICE, MODULAR ARRANGEMENT DECISION SYSTEM, AND MODULAR ARRANGEMENT DECISION METHOD

(71) Applicant: FUJITSU LIMITED, Kawasaki-shi (JP)

(72) Inventors: Shigeki FUKUTA, Setagaya (JP); Itaru NAKAGAWA, Kawasaki (JP); KAZUO SASAKI, Kobe (JP)

(21) Appl. No.: 14/310,336

(22) Filed: Jun. 20, 2014

(30) Foreign Application Priority Data
Jul. 12, 2013 (JP) 2013-147028

(51) Int. Cl. H04L 12/801; H04L 12/26

(52) U.S. Cl. CPC H04L 47/33; H04L 43/02
USPC 370/236

(57) ABSTRACT

A modular arrangement decision device includes a storing unit and selecting units. Network information of a network connected to nodes and an identifier for identifying a module to be arranged in a node are stored in the storing unit. The first selecting unit selects a predetermined number of pieces of information with a higher degree of evaluation from among first information indicating a node in which the module is to be arranged among the multiple nodes, and second information obtained by changing the first information. The second selecting unit selects a predetermined number of pieces of information with a smaller number of unmatched conditions, from the information selected by the first selecting unit and third information obtained by changing the information selected by the first selecting unit. The third selecting unit selects information in which an evaluation value and a number of unmatched conditions satisfy a predetermined criteria.

### CROSS-REFERENCE TO RELATED APPLICATION(S)

This application is based upon and claims the benefit of priority of the prior Japanese Patent Application No. 2013-147028, filed on Jul. 12, 2013, the entire contents of which are incorporated herein by reference.

### FIELD

The embodiment discussed herein is related to a modular arrangement decision device, a modular arrangement decision system, and a modular arrangement decision method.

### BACKGROUND

There is a known sensor network that acquires, as an event, sensing data obtained through sensing by a sensor node. Various services, such as outputting of an alarm or control of equipment, are provided via the sensor network in accordance with the event acquired by a server node.

When events from sensor nodes are to be collected by the server node, all of the events are sent to, as notifications in a concentrated manner, to the server node. Consequently, the processing load applied to the server node is increased and, furthermore, the network bandwidth becomes tight in accordance with an increase in the network traffic. Furthermore, in the sensor network, there is a predetermined constraint condition, in which an amount of process performed by a certain sensor node is made lower than that performed by another sensor node. As to further information, see Japanese Laid-open Patent Publication No. 2008-269250, Japanese Laid-open Patent Publication No. 2012-175418, Japanese Laid-open Patent Publication No. 7-262115, and Japanese Laid-open Patent Publication No. 11-345257, for example.

It is conceivable to use the following technology as an example of a technology that decides a module to be arranged in a lower level node, such as a sensor node or a relay node that relays an event, such that the predetermined constraint condition is satisfied while suppressing the load applied to a server node and suppressing the network traffic. For example, the technology that decides a module to be arranged in a lower level node decides, first, a collection path for an event in accordance with the occurrence status of the event or the topology of a sensor network. Then, on the basis of the decided collection path, the technology that decides a module to be arranged in a lower level node performs the following process on all combinations between lower level nodes and modules that process an event arranged in a lower level node. Namely, for all of the combinations, the technology that decides a module to be arranged in a lower level node calculates a first evaluation value that indicates the load applied to a server node, a second evaluation value that indicates network traffic, and a third evaluation value that indicates the number of conditions that violate the predetermined constraint conditions. Then, on the basis of the first evaluation value, the second evaluation value, and the third evaluation value, the technology that decides a module to be arranged in a lower level node decides a module to be arranged in the lower level node.

However, with the technology that decides a module described above, because the various kinds of evaluation values described above are calculated, there is a problem in that it takes a long time to decide which module is to be arranged in which node.

### SUMMARY

According to an aspect of an embodiment, a modular arrangement decision device includes a storing unit, a first selecting unit, a second selecting unit, a third selecting unit, and an output unit. The storing unit stores therein network information indicating a network to which multiple nodes each of which sends a detected event or relays the event are connected and stores therein an identifier for identifying a module that performs a process on the event. The first selecting unit selects a predetermined number of pieces of information with a higher degree of evaluation from among pieces of first information and pieces of second information, on a basis of an evaluation value that indicates a degree of evaluation of the pieces of the first information and the pieces of the second information, the first information indicating a node in which the module is to be arranged among the multiple nodes, and the second information being obtained by changing the node in which the module is to be arranged from the first information. The second selecting unit selects a predetermined number of pieces of information with a smaller number of unmatched conditions among a predetermined number of conditions, from among the pieces of information selected by the first selecting unit and pieces of third information obtained by changing a node in which a module is to be arranged from the pieces of information selected by the first selecting unit. The third selecting unit selects, on the basis of an evaluation value that indicates a degree of evaluation of the pieces of information selected by the second selecting unit and pieces of fourth information obtained by changing a node in which a module is to be arranged from the information selected by the second selecting unit, and on the basis of a number of unmatched conditions among the predetermined number of the conditions in the pieces of information selected by the second selecting unit and the fourth information, information in which the evaluation value and the number of unmatched conditions satisfy a predetermined criteria from among the pieces of the information selected by the second selecting unit and the fourth information. The output unit outputs the information selected by the third selecting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a system configuration of a sensor network system that is an example of a modular arrangement decision system according to an embodiment of the present invention;

FIG. 2 is a block diagram illustrating an example of a functional configuration of a server node according to the embodiment;

FIG. 3 is a schematic diagram illustrating an example of a connection mode of various nodes in a sensor network system indicated by a topology stored in a topology storing unit;

FIG. 4 is a schematic diagram illustrating an example of a definition stored in a module definition storing unit;

FIG. 5 is a schematic diagram illustrating an example of an initial solution;

FIG. 6 is a schematic diagram illustrating instances and nodes, in each of which the instance is arranged, indicated by the initial solutions illustrated in FIG. 5;

FIG. 7 is a schematic diagram illustrating an example of a second parental generation;

FIG. 8 is a schematic diagram illustrating an example of probability information obtained when a global search is performed;

FIG. 9 is a schematic diagram illustrating an example of a calculation method of a next generation;

FIG. 10 is a schematic diagram illustrating an example of probability information obtained when a constraint search and a peripheral search are performed;

FIG. 11 is a schematic diagram illustrating an example of a new next generation obtained by performing mutation on the next generation;

FIG. 12 is a schematic diagram illustrating an example of a calculation method of a constraint evaluation value;

FIG. 13 is a schematic diagram illustrating an example of a calculation method of a constraint evaluation value;

FIG. 14 is a schematic diagram illustrating an example of a calculation method of a constraint evaluation value;

FIG. 15 is a schematic diagram illustrating an example of a calculation method of a constraint evaluation value;

FIG. 16 is a schematic diagram illustrating an example of a predetermined weighting constant;

FIG. 17A is a block diagram illustrating an example of a functional configuration of a sensor node according to the embodiment;

FIG. 17B is a block diagram illustrating an example of a functional configuration of a GW node according to the embodiment;

FIG. 18A is a flowchart illustrating a flow of a modular arrangement decision process according to the embodiment;

FIG. 18B is a flowchart illustrating the flow of the modular arrangement decision process according to the embodiment;

FIG. 19 is a schematic diagram illustrating an example of a process performed by the server node according to the embodiment;

FIG. 20 is a block diagram illustrating another example of the functional configuration of the server node according to the embodiment; and

FIG. 21 is a block diagram illustrating a computer that executes a modular arrangement decision program.

### DESCRIPTION OF EMBODIMENTS

Preferred embodiments of the present invention will be explained with reference to accompanying drawings.

A preferred embodiment of a server node, which is an example of a modular arrangement decision device disclosed in the present invention, a sensor network system, which is an example of a modular arrangement decision system disclosed in the present invention, and a modular arrangement decision method disclosed in the present invention will be described in detail below with reference to the accompanying drawings. The present invention is not limited to the embodiment.

Exemplary configuration of a sensor network system according to the embodiment

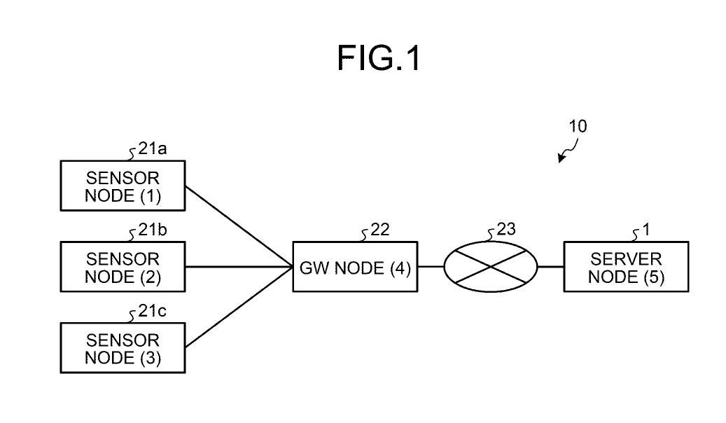

FIG. 1 is a schematic diagram illustrating a system configuration of a sensor network system that is an example of a modular arrangement decision system according to an embodiment of the present invention. A sensor network system 10 illustrated in FIG. 1 is a system that decides which node, i.e., a sensor node, a GW node, and a server node, is used to arrange various modules that perform a process for processing an event. The event mentioned here indicates data obtained through sensing by a sensor node or data obtained by processing on the data that has been obtained through the sensing.

As illustrated in FIG. 1, the sensor network system 10 includes a server node (5) 1, three sensor nodes, such as a sensor node (1) 21a, a sensor node (2) 21b, and a sensor node (3) 21c, and a gateway (GW) node (4) 22. The number indicated by “(1)” in the “sensor node (1) 21a” indicates an identifier (node ID) that is used to identify a node. For example, the node indicated by the node ID “1” is the sensor node 21a. Similarly, the node indicated by the node ID “2” is the sensor node 21b, the node indicated by the node ID “3” is the sensor node 21c, the node indicated by the node ID “4” is the GW node 22, and the node indicated by the node ID “5” is the server node 1. In a description below, a description of the identifier will sometimes be omitted.

In the example illustrated in FIG. 1, the server node 1 and the GW node 22 are connected via a network 23 such that the server node 1 and the GW node 22 communicate with each other. An example of the network 23 include, a communication network, such as the Internet, a local area network (LAN), a virtual private network (VPN), or the like irrespective of the network being wired or wireless. FIG. 1 illustrates a case, as an example, in which the sensor network system 10 includes three sensor nodes 21a to 21c; however, the sensor network system 10 may also include an arbitrary number of sensor nodes. Furthermore, in a description below, if there is no need to distinguish among the three sensor nodes 21a to 21c, they are collectively referred to as a “sensor node 21”. FIG. 1 illustrates an example of a case in which the sensor network system 10 includes the single GW node 22; however, the sensor network system 10 may also include an arbitrary number of GW nodes.

In the sensor network system 10 illustrated in FIG. 1, the server node 1 collects the event sent from the sensor node 21 via the GW node 22 and the network 23.

The sensor node 21 is a communication terminal on which a sensor is mounted. Examples of the sensor node 21 include various kinds of equipment, such as, a personal computer, peripheral equipment of the personal computer, audio visual (AV) equipment, a mobile terminal, i.e., a mobile phone or a personal handy-phone system (PHS), and a home appliance. Furthermore, an example of the sensor mounted on the sensor node 21 includes an environmental sensor, such as a luminance sensor that detects luminance, a temperature sensor that detects a temperature, a humidity sensor that detects humidity, and a temperature and humidity sensor that detects a temperature and humidity. However, the sensor mounted on the sensor node 21 is not limited to the environmental sensor. For example, the sensor mounted on the sensor node 21 may also be various types of sensors, such as a global positioning system (GPS) sensor, an acceleration sensor, a gyro sensor, or the like.

In the following, a description will be given of a case in which the three sensor nodes 21a to 21c are luminance sensors, the sensor node 21a is arranged in a “room S501”, and the sensor node 21b and the sensor node 21c are arranged in a “room S503”.

The GW node 22 is a node that relays communication between the server node 1 and the sensor node 21. For example, the GW node 22 receives an event sent from the sensor node 21 and then sends the received event to the server node 1 via the network 23. In a description below, nodes, i.e., the sensor node 21 and GW node 22, which are other than the server node 1 that is the root node in a sensor network are sometimes referred to as “lower level nodes”.

The server node 1 has a function as the root node in the sensor network. The server node 1 is a server that decides which node i.e., the sensor node, the GW node, and the server node, is used to arrange the various modules that performs a process for processing an event.

Example of functional configuration of server node 1

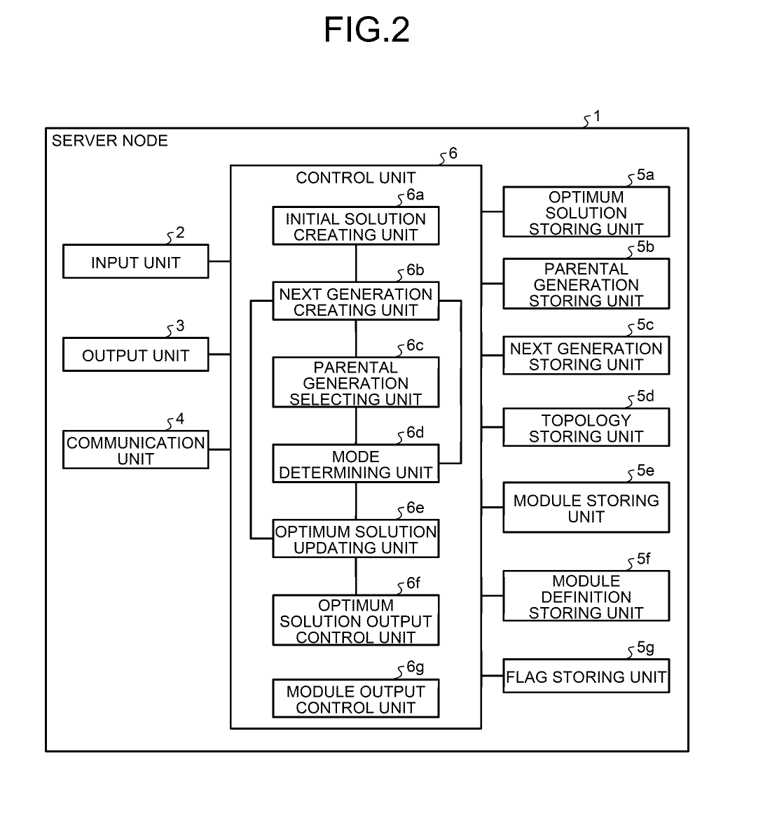

In the following, an example of a functional configuration of the server node 1 according to the embodiment will be described. FIG. 2 is a block diagram illustrating an example of a functional configuration of a server node according to the embodiment. As in the example illustrated in FIG. 2, the server node 1 includes an input unit 2, an output unit 3, a communication unit 4, a control unit 6, an optimum solution storing unit 5a, a parental generation storing unit 5b, a next generation storing unit 5c, a topology storing unit 5d, a module storing unit 5e, a module definition storing unit 5f, and a flag storing unit 5g.

The input unit 2 inputs various kinds of information to the server node 1. For example, when the input unit 2 receives an instruction to perform a modular arrangement decision process, which will be described later, from a user of the server node 1, the input unit 2 inputs the received instruction to the server node 1. An example of the input unit 2 used as a device includes a keyboard or a mouse.

The output unit 3 outputs various kinds of information. For example, the output unit 3 is controlled by a process, which will be described later, performed by an optimum solution output control unit 6f such that the output unit 3 displays an optimum solution, which will be described later. Examples of the output unit 3 used as a device include various display devices, such as a liquid crystal display or an audio output device that outputs audio.

The communication unit 4 communicates between the server node 1 and the lower level node. For example, the communication unit 4 is controlled by a process, which will be described later, performed by a module output control unit 6g such that the communication unit 4 sends a module to a lower level node. An example of the communication unit 4 used as a device includes a network interface card that is used to perform various kinds of communication.

The optimum solution storing unit 5a stores therein, in advance, an optimum solution with a predetermined value, for example, “1000” is used as an initial value. The optimum solution is updated in a modular arrangement decision process, which will be described later, performed by an optimum solution updating unit 6e.

The parental generation storing unit 5b stores therein parental generations, which will be described later. The parental generations stored in the parental generation storing unit 5b are updated. In the embodiment, a description will be given of a case in which two parental generations are present and these two parental generations are updated; however, the number of parental generations is not limited thereto and an arbitrary number of parental generations may be used.

The next generation storing unit 5c stores therein two next generations when a process, which will be described later, is performed by a next generation creating unit 6b. The next generations stored in the next generation storing unit 5c are updated.

The topology storing unit 5d stores therein information that indicates a connection mode i.e., the topology, of various nodes, i.e., the server node 1, the sensor node 21, and the GW node 22, in the sensor network system 10. The topology is stored in the topology storing unit 5d by using, for example, the following method. For example, by using the technology described in Japanese Laid-open Patent Publication No. 2013-047922, the server node 1 acquires, from each of the lower level nodes, connection information that indicates the connection relation between a lower level node and a higher level node to which the lower level node is connected. Furthermore, if the server node 1 receives an event sent from a lower level node and if information that indicates the location in which the lower level node is arranged is included in attribute information in the received event, the server node 1 specifies, from the attribute information, the location in which the lower level node is arranged. Then, by using the connection information that is acquired from each of the lower level nodes and the location in which each of the lower level nodes is arranged, the server node 1 creates information indicating the connection mode of the various nodes in the sensor network system 10. Then, the server node 1 stores, as the topology, the created information in the topology storing unit 5d. Furthermore, the topology may also be stored in the topology storing unit 5d by a user inputting the topology to the server node 1 via the input unit 2 and inputting, to the server node 1, an instruction to store the input topology in the topology storing unit 5d.

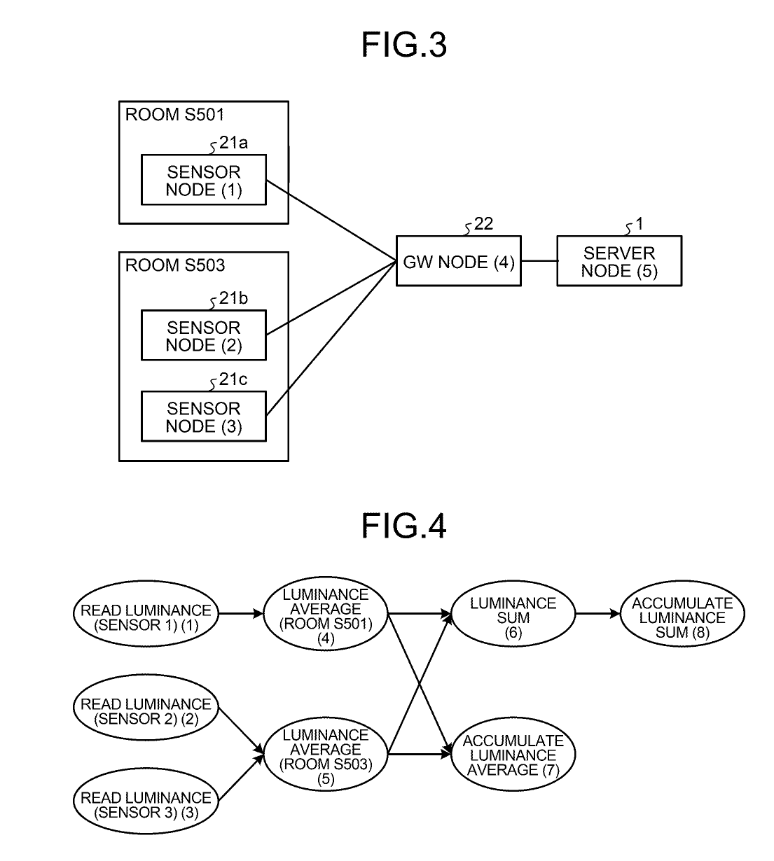

FIG. 3 is a schematic diagram illustrating an example of the connection mode of various nodes in the sensor network system 10 indicated by the topology stored in a topology storing unit 5d. FIG. 3 illustrates an example of a connection mode when the sensor node 21a, the sensor node 21b, and the sensor node 21c are connected to the GW node 22 and the GW node 22 is connected to the server node 1. Furthermore, the example illustrated in FIG. 3 indicates that the sensor node 21a is arranged in the “room S501” and the sensor node 21b and the sensor node 21c are arranged in the “room S503”.

The module definition storing unit 5f stores therein the definition about instances of modules executed by various nodes in the sensor network system 10. The definition is stored in the module definition storing unit 5f by using, for example, the following method. For example, the server node 1 receives, via the input unit 2, the definition about an instance of a module programmed by a developer of the module and then stores the received definition in the module definition storing unit 5f.

FIG. 4 is a schematic diagram illustrating an example of the definition stored in a module definition storing unit 5f. The example illustrated in FIG. 4 indicates the connection relation of instances that are stored in the module definition storing unit 5f as the definition and each of which executes, for each piece of data, a process in the flow of the process indicated by the modules. In the example illustrated in FIG. 4, the symbol “(N)” (N=1, 2, . . . , 8) indicates an identifier (instance ID) that is used to identify each instance.

For example, the instance ID “1” indicates the instance that reads luminance detected by the sensor node arranged in the room S501. The instance IDs “2” and “3” both indicate the instance that reads luminance detected by the sensor node arranged in the room S503. Furthermore, the instance ID “4” indicates the instance that calculates the average value of the luminance of the room S501 by using the luminance that has been read by the instance indicated by the instance ID “1”.

Furthermore, the instance ID “5” indicates the instance that calculates the average value of the luminance in the room S503 by using the luminance read by the instances indicated by the instance IDs “2” and “3”, respectively. Furthermore, the instance ID “6” indicates the instance that calculates the sum of the average values of the luminance by using the average values of the luminance calculated by the instances indicated by the instance IDs “4” and “5”, respectively. Furthermore, the instance ID “7” indicates the instance that accumulates the average values of the luminance in a storing unit by using the average values of the luminance calculated by the instances indicated by the instance IDs “4” and “5”, respectively. Furthermore, the instance ID “8” indicates the instance that accumulates the sum of the average values of the luminance in the storing unit by using the sum of the average values of the luminance calculated by the instance indicated by the instance ID “6”.

The module storing unit 5e stores therein each of the instances of the modules. These instances are stored in the module storing unit 5e by using, for example, the following method. For example, the server node 1 receives, via the input unit 2, the binary code and the instance ID of the instance of the module that is programmed by a developer of the module and then stores the binary code of the received instance in the module storing unit 5e together with the instance ID. For example, the module storing unit 5e stores, in an associated manner, each of the binary codes of the eight instances illustrated in FIG. 4 and the instance IDs associated with the instances.

The flag storing unit 5g stores therein a 2-bit flag. For example, one of the values of “1”, “2”, “3” is set to the flag. The value of “1” indicates a global search mode, which will be described later. The value of “2” indicates a constraint search mode, which will be described later. The value of “3” indicates a peripheral search mode, which will be described later.

A description will be given here by referring back to FIG. 2. The control unit 6 includes an initial solution creating unit 6a, the next generation creating unit 6b, a parental generation selecting unit 6c, a mode determining unit 6d, the optimum solution updating unit 6e, the optimum solution output control unit 6f, and the module output control unit 6g. The control unit 6 is a circuit, such as an application specific integrated circuit (ASIC), a field programmable gate array (FPGA), a central processing unit (CPU), a micro processing unit (MPU), or the like.

The initial solution creating unit 6a creates an initial solution that is a solution indicating the relationship between an instance and a node in which the instance is arranged and that is one of the two first parental generations in the modular arrangement decision process.

In the following, the initial solution creating unit 6a will be described. When an instruction to execute a modular arrangement decision process is input from the input unit 2, the initial solution creating unit 6a first acquires the topology from the topology storing unit 5d. Then, the initial solution creating unit 6a acquires, from the module definition storing unit 5f, the definition stored in the module definition storing unit 5f.

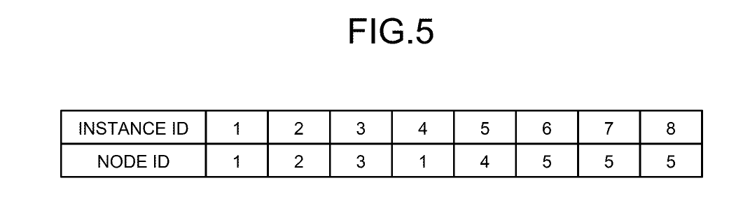

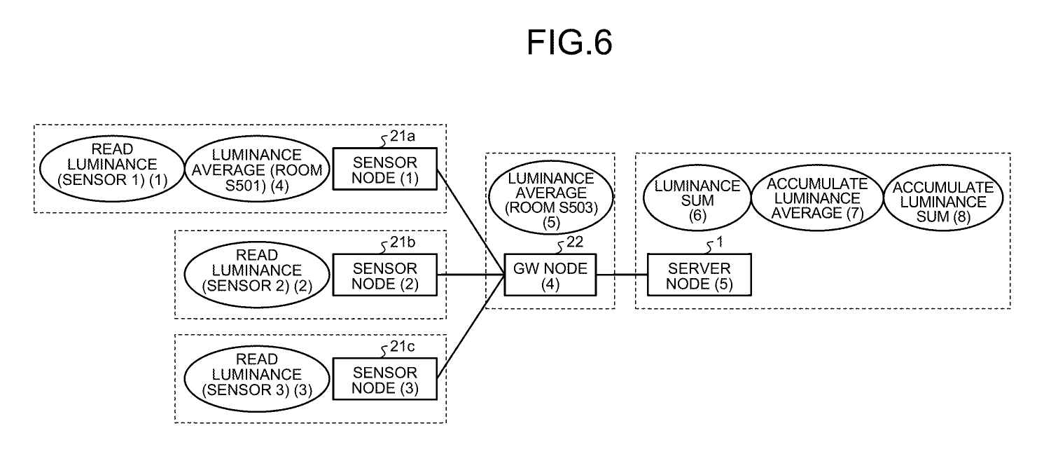

Then, the initial solution creating unit 6a creates an initial solution. For example, by using the technology described in Japanese Laid-open Patent Publication No. 2013-047922, the initial solution creating unit 6a derives, from the topology and the definition, the node ID of the node at the destination of the arrangement and the instance ID of the instance that is arranged in the node indicated by the node ID. Then, the initial solution creating unit 6a associates the node ID with the instance ID and creates an initial solution. FIG. 5 is a schematic diagram illustrating an example of an initial solution. FIG. 6 is a schematic diagram illustrating instances and nodes, in each of which the instance is arranged, indicated by the initial solution illustrated as an example in FIG. 5.

In the initial solution illustrated as an example in FIG. 5, the instance ID “1” is associated with the node ID “1”. In the initial solution illustrated in FIG. 5, the instance ID “4” is associated with the node ID “1”. This indicates a case, as illustrated in the example in FIG. 6, in which the instance indicated by the instance ID “1” and the instance indicated by the instance ID “4” are arranged in the sensor node 21a indicated by the node ID “1”.

Furthermore, in the initial solution illustrated in FIG. 5, the instance ID “2” is associated with the node ID “2”. This indicates a case, as illustrated in the example in FIG. 6, in which the instance indicated by the instance ID “2” is arranged in the sensor node 21b indicated by the node ID “2”.

Furthermore, in the initial solution illustrated in FIG. 5, the instance ID “3” is associated with the node ID “3”. This indicates a case, as illustrated in the example in FIG. 6, in which the instance indicated by the instance ID “3” is arranged in the sensor node 21c indicated by the node ID “3”.

Furthermore, in the initial solution illustrated in FIG. 5, the instance ID “5” is associated with the node ID “4”. This indicates a case, as illustrated in the example in FIG. 6, in which the instance indicated by the instance ID “5” is arranged in the GW node 22 indicated by the node ID “4”.

Furthermore, in the initial solution illustrated in FIG. 5, the instance ID “6” is associated with the node ID “5”. Furthermore, in the initial solution illustrated in FIG. 5, the instance ID “7” is associated with the node ID “5”. Furthermore, in the initial solution illustrated in FIG. 5, the instance ID “8” is associated with the node ID “5”. This indicates a case, as illustrated in the example in FIG. 6, in which the instance indicated by the instance ID “6”, the instance indicated by the instance ID “7”, and the instance indicated by the instance ID “8” are arranged in the server node 1 indicated by the node ID “5”.

Then, the initial solution creating unit 6a stores, in the parental generation storing unit 5b, the created initial solution as a first parental generation. For example, the initial solution creating unit 6a stores, in the parental generation storing unit 5b, the initial solution illustrated in the example in FIG. 5 as the first parental generation.

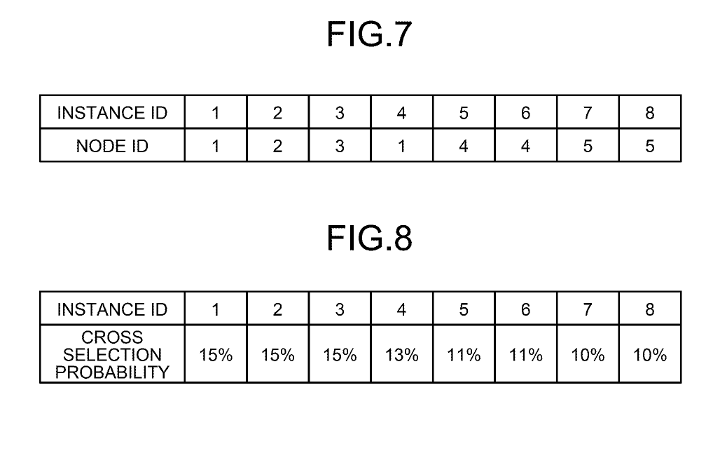

Then, by using a genetic algorithm, the initial solution creating unit 6a creates, from the first parental generation, a new solution due to the mutation and stores the created solution as a second parental generation in the parental generation storing unit 5b. FIG. 7 is a schematic diagram illustrating an example of a second parental generation. For example, the initial solution creating unit 6a creates, from the first parental generation illustrated in the example in FIG. 5, the new solution due to the mutation as illustrated in the example in FIG. 7 and then stores the created solution as the second parental generation in the parental generation storing unit 5b. Consequently, two parental generations are stored in the parental generation storing unit 5b.

Then, the initial solution creating unit 6a sets “1” to the flag stored in the flag storing unit 5g. Consequently, the mode in the modular arrangement decision process becomes a global search mode.

The next generation creating unit 6b creates a next generation from a parental generation. In the following, the next generation creating unit 6b will be described. For example, the next generation creating unit 6b refers to the flag stored in the flag storing unit 5g at a predetermined timing. The predetermined timing will be described below. For example, there are seven kinds of timing for the predetermined timing. A first timing is the timing at which the initial solution creating unit 6a sets the flag stored in the flag storing unit 5g to “1”. A second timing is the timing at which the mode determining unit 6d determines that the number of violations of the constraint of at least one parental generation of the two parental generations is not zero. Furthermore, a third timing is the timing at which the mode determining unit 6d updates the value of the flag stored in the flag storing unit 5g to “3” and sets the mode in the modular arrangement decision process to the peripheral search mode. Furthermore, a fourth timing is the timing at which the mode determining unit 6d updates the value of the flag in the flag storing unit 5g to “2” and sets the mode in the modular arrangement decision process to the constraint search mode. A fifth timing is the timing at which the optimum solution updating unit 6e updates the optimum solution stored in the optimum solution storing unit 5a. A sixth timing is the timing at which the optimum solution updating unit 6e determines that the number of violations of the constraint is zero in the two parental generations and determines that no parental generation is evaluated higher than the optimum solution stored in the optimum solution storing unit 5a. A seventh timing is the timing at which the mode determining unit 6d determines that a parental generation is not updated while the next generation is being updated a predetermined number of times.

Then, when a flag is referred to, if the value of the flag is “1”, the next generation creating unit 6b acquires two parental generations stored in the parental generation storing unit 5b. Then, in accordance with a probability (cross selection probability) of selecting each of the instance IDs indicated by probability information on the global search, the next generation creating unit 6b selects the instance IDs in the two parental generations by a predetermined number of crosses (for example, “3”). The probability information on the global search is stored in an internal memory in the next generation creating unit 6b. FIG. 8 is a schematic diagram illustrating an example of probability information on the global search.

The probability information illustrated in FIG. 8 indicates that the probability of selecting the instance ID “1” is “15%”. Furthermore, the probability information illustrated in FIG. 8 indicates that the probability of selecting the instance ID “2” is “15%”. Furthermore, the probability information illustrated in FIG. 8 indicates that the probability of selecting the instance ID “3” is “15%”. Furthermore, the probability information illustrated in FIG. 8 indicates that the probability of selecting the instance ID “4” is “13%”. Furthermore, the probability information illustrated in FIG. 8 indicates that the probability of selecting the instance ID “5” is “11%”. Furthermore, the probability information illustrated in FIG. 8 indicates that the probability of selecting the instance ID “6” is “11%”. Furthermore, the probability information illustrated in FIG. 8 indicates that the probability of selecting the instance ID “7” is “10%”. Furthermore, the probability information illustrated in FIG. 8 indicates that the probability of selecting the instance ID “8” is “10%”.

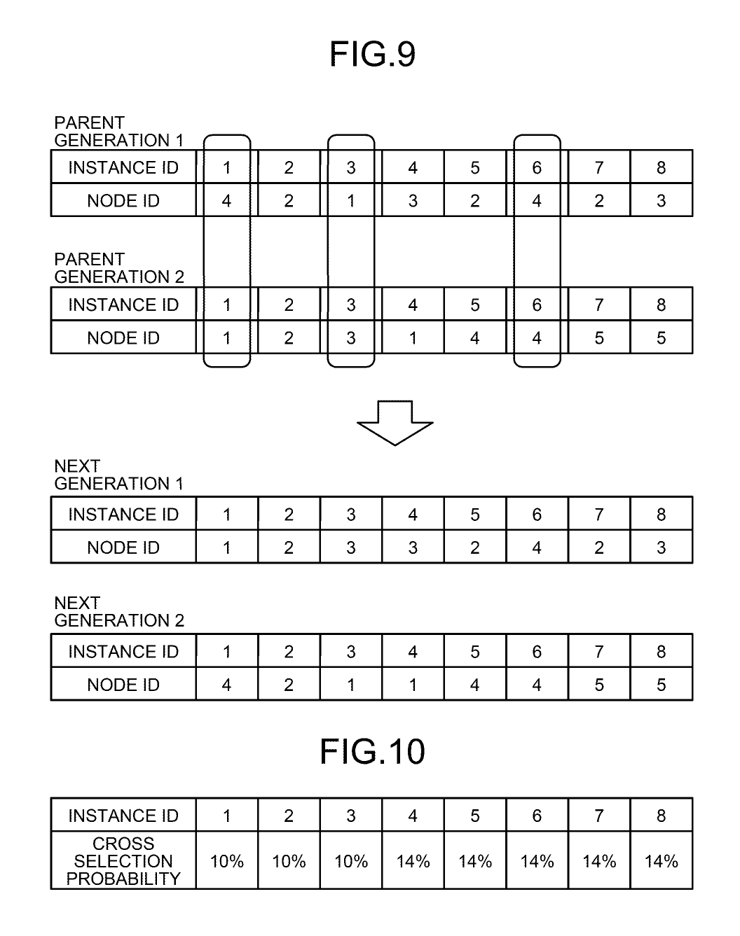

Then, by interchanging the node ID associated with the selected instance ID in one parental generation with the node ID associated with the selected instance ID in the other parental generation, the next generation creating unit 6b crosses the two parental generations and creates two next generations. FIG. 9 is a schematic diagram illustrating an example of a calculation method of a next generation. In the example illustrated in FIG. 9, the first parental generation illustrated in the example in FIG. 5 is indicated by the “parental generation 1” and the second parental generation illustrated in the example in FIG. 7 is indicated by the “parental generation 2”. Furthermore, the example illustrated in FIG. 9 indicates a case in which the next generation creating unit 6b selects the instance ID “1”, the instance ID “3”, and the instance ID “6” in each of the parental generation 1 and the parental generation 2. As illustrated in the example in FIG. 9, the next generation creating unit 6b interchanges the node ID “4” associated with the selected instance ID “1” in the parental generation 1 with the node ID “1” associated with the selected instance ID “1” in the parental generation 2. Furthermore, as illustrated in the example in FIG. 9, the next generation creating unit 6b interchanges the node ID “1” associated with the selected instance ID “3” in the parental generation 1 with the node ID “3” associated with the selected instance ID “3” in the parental generation 2. Furthermore, as illustrated in the example in FIG. 9, the next generation creating unit 6b interchanges the node ID “4” associated with the selected instance ID “6” in the parental generation 1 with the node ID “4” associated with the selected instance ID “6” in the parental generation 2. In this way, the next generation creating unit 6b creates two next generations, i.e., the next generation 1 and the next generation 2, by crossing the two parental generations, i.e., the parental generation 1 and the parental generation 2.

Furthermore, if the value of the flag referred to is “2” or “3”, the next generation creating unit 6b acquires two parental generations stored in the parental generation storing unit 5b. Then, in accordance with the probability (cross selection probability) of selecting each instance ID indicated by the probability information when a constraint search and a peripheral search are performed, the next generation creating unit 6b selects instance IDs in the two parental generations by a predetermined number of crosses (for example, “3”). The probability information obtained when the constraint search and the peripheral search are performed is stored in the internal memory in the next generation creating unit 6b. FIG. 10 is a schematic diagram illustrating an example of probability information obtained when a constraint search and a peripheral search are performed.

The probability information illustrated in FIG. 10 indicates that the probability of selecting the instance ID “1” is “10%”. Furthermore, the probability information illustrated in FIG. 10 indicates that the probability of selecting the instance ID “2” is “10%”. Furthermore, the probability information illustrated in FIG. 10 indicates that the probability of selecting the instance ID “3” is “10%”. Furthermore, the probability information illustrated in FIG. 10 indicates that the probability of selecting the instance ID “4” is “14%”. Furthermore, the probability information illustrated in FIG. 10 indicates that the probability of selecting the instance ID “5” is “14%”. Furthermore, the probability information illustrated in FIG. 10 indicates that the probability of selecting the instance ID “6” is “14%”. Furthermore, the probability information illustrated in FIG. 10 indicates that the probability of selecting the instance ID “7” is “14%”. Furthermore, the probability information illustrated in FIG. 10 indicates that the probability of selecting the instance ID “8” is “14%”.

Then, by interchanging the node ID associated with the selected instance ID in one parental generation with the node ID associated with the selected instance ID in the other parental generation, the next generation creating unit 6b crosses the two parental generations and then creates two next generations.

At this point, when the probability information illustrated in FIG. 8 is compared with the probability information illustrated in FIG. 10, this indicates that the next generation creating unit 6b selects instance IDs as follows. Namely, if the value of the flag that is referred to is “1”, the next generation creating unit 6b selects, with high probability, the instance ID of the instance arranged on the upstream side in the flow direction of an event in the flow of a module process when compared with a case in which the value of the flag is “2” or “3”. Then, the next generation creating unit 6b creates a next generation by changing the node in which the instance indicated by the selected instance ID is arranged. At this point, as the instance arranged at the changed node that is located more upstream side in the flow direction of the event, a possibility of a significant change in an evaluation value between the parental generation and the next generation becomes high. Consequently, in the global search mode, there is a high possibility that an evaluation value obtained when a module is arranged in a node as indicated by the next generation is significantly changed from an evaluation value obtained when a module is arranged in a node as indicated by the parental generation when compared with a case in which the constraint search mode or the peripheral search mode is used.

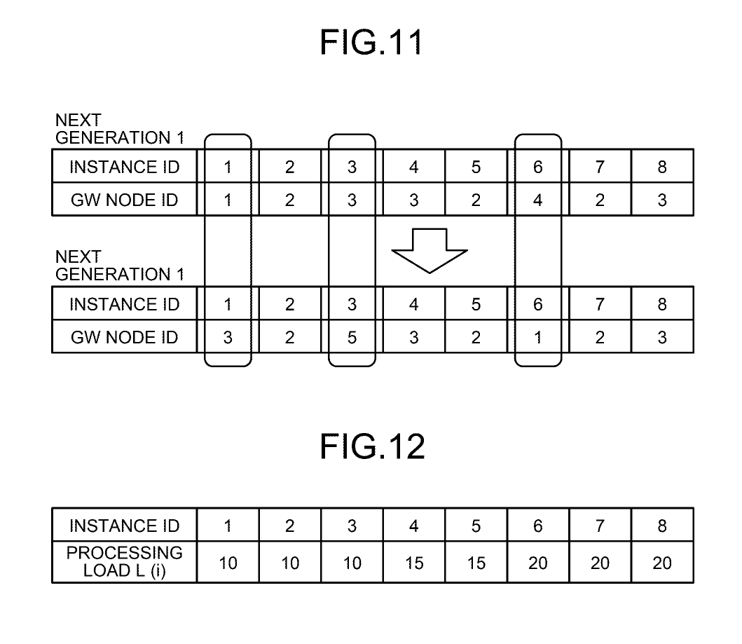

Then, the next generation creating unit 6b mutates the created next generation at a predetermined probability (0.1% to 5%) and creates a new next generation. FIG. 11 is a schematic diagram illustrating an example of a new next generation obtained by performing mutation on the next generation. For example, as illustrated in the example in FIG. 11, the next generation creating unit 6b mutates the “next generation 1” illustrated in FIG. 9 (the next generation in the upper portion of FIG. 11) by a predetermined mutation numbers (for example, “3”) and creates a new “next generation 1” (the next generation in the lower portion of FIG. 11).

Furthermore, the next generation creating unit 6b may also mutate the created next generation and then create a new next generation by using another method as follows. For example, if the value of the flag is “1”, the next generation creating unit 6b selects an instance ID in the parental generation by the predetermined mutation numbers (for example, “3”) in accordance with the probability of selecting each instance ID indicated by the probability information in the global search described above. Then, the next generation creating unit 6b randomly creates integers by the predetermined mutation numbers in the range of “1” to “5”. Then, by changing the value of the node ID associated with the selected instance ID to the created integer, the next generation creating unit 6b creates a next generation.

Then, the next generation creating unit 6b stores created two next generations in the next generation storing unit 5c. If two next generations have already been stored in the next generation storing unit 5c, the next generation creating unit 6b updates the two next generations that have already been stored in the next generation storing unit 5c to the created two next generations.

The parental generation selecting unit 6c selects a new parental generation from the two next generations. In the following, the parental generation selecting unit 6c will be described. For example, the parental generation selecting unit 6c first acquires the two parental generations stored in the parental generation storing unit 5b and two next generations stored in the next generation storing unit 5c. Then, the parental generation selecting unit 6c refers to the flag stored in the flag storing unit 5g.

If the value of the flag that is referred to is “1”, for each of the two parental generations, the parental generation selecting unit 6c arranges an instance in a node as indicated by the parental generation and calculates an evaluation value that is used when the node executes the instance. Furthermore, for each of the two next generations, the parental generation selecting unit 6c arranges an instance in a node as indicated by the next generation and calculates an evaluation value that is used when the node executes the instance. For example, by using an evaluation function used for calculating a communication cost, the parental generation selecting unit 6c calculates a communication cost of each of the two parental generations and the two next generations.

Then, the parental generation selecting unit 6c selects, as new parental generations from among the two parental generations and the two next generations, the top two generations with the highest evaluation indicated by the evaluation values. For example, if a communication cost is calculated as an evaluation value, because the evaluation becomes high as the communication cost is decreased, the parental generation selecting unit 6c selects, as new parental generations from among the two parental generations and the two next generations, the top two generations with the lowest evaluation value. Then, the parental generation selecting unit 6c stores the two new parental generations in the parental generation storing unit 5b and updates the two parental generations stored in the parental generation storing unit 5b.

Furthermore, if the value of the flag that is referred to is “2”, for each of the two parental generations, the parental generation selecting unit 6c arranges a module in a node as indicated by the parental generation and then calculates a constraint evaluation value that is used when the node executes the instance. Furthermore, for each of the two next generations, the parental generation selecting unit 6c arranges a module in a node as indicated by the next generation and then calculates a constraint evaluation value that is used when the node executes the instance.

In the following, a description will be given of an example of a calculation method of a constraint evaluation value calculated by the parental generation selecting unit 6c. For example, the constraint evaluation value is represented by the sum of the number of nodes in which the processing load obtained when an instance arranged in the corresponding node exceeds the processing throughput and the number of paths in which the communication traffic obtained when the instance is executed exceeds the communication bandwidth. FIGS. 12, 13, 14, and 15 are schematic diagrams each illustrating an example of the calculation method of the constraint evaluation values.

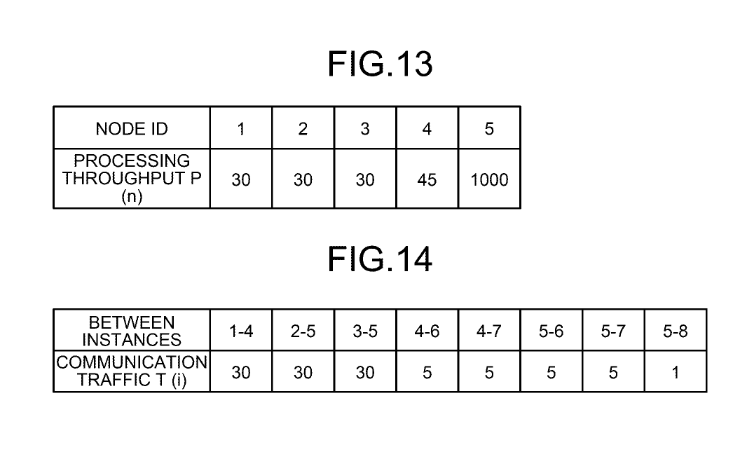

First, an example of a method for calculating the number of nodes in which the processing load obtained when an instance arranged in the corresponding node exceeds the processing throughput will be described with reference to FIGS. 12 and 13. FIG. 12 illustrates the association relationship between the instance ID and the processing load obtained when the instance indicated by the instance ID performs a process. The processing load can be obtained by, for example, extracting from a load monitor running in a node, by measuring the load by an emulator at the time of virtual operation, or by calculating from a load prospect function defined for each instance. The association relationship between the instance ID and the processing load described above is stored, in advance, in the internal memory in the parental generation selecting unit 6c.

The processing load L (i) illustrated in FIG. 12 as an example indicates the processing load obtained when a process is performed on the instance indicated by the instance ID “i”.

For example, the example illustrated in FIG. 12 indicates a case in which the processing load obtained when a process is performed on the instance indicated by the instance ID “1” is “10”. Furthermore, the example illustrated in FIG. 12 indicates a case in which the processing load obtained when a process is performed on the instance indicated by the instance ID “2” is “10”.

Furthermore, the example illustrated in FIG. 12 indicates a case in which the processing load obtained when a process is performed on the instance indicated by the instance ID “3” is “10”. Furthermore, the example illustrated in FIG. 12 indicates a case in which the processing load obtained when a process is performed on the instance indicated by the instance ID “4” is “15”.

Furthermore, the example illustrated in FIG. 12 indicates a case in which the processing load obtained when a process is performed on the instance indicated by the instance ID “5” is “15”. Furthermore, the example illustrated in FIG. 12 indicates a case in which the processing load obtained when a process is performed on the instance indicated by the instance ID “6” is “20”.

Furthermore, the example illustrated in FIG. 12 indicates a case in which the processing load obtained when a process is performed on the instance indicated by the instance ID “7” is “20”. Furthermore, the example illustrated in FIG. 12 indicates a case in which the processing load obtained when a process is performed on the instance indicated by the instance ID “8” is “20”.

FIG. 13 illustrates an example of the association relationship between the node ID and the processing throughput of a node indicated by a node ID. The processing throughput can be obtained from, for example, the performance of a central processing unit (CPU) or the result of the benchmark. The relationship between the node ID and the processing throughput described above is stored, in advance, in the internal memory in the parental generation selecting unit 6c.

The processing throughput P (n) illustrated in FIG. 13 indicates the processing throughput of the node indicated by the node ID “n”. For example, the example illustrated in FIG. 13 indicates a case in which the processing throughput indicated by the node ID “1” is “30”. Furthermore, the example illustrated in FIG. 13 indicates a case in which the processing throughput indicated by the node ID “2” is “30”.

Furthermore, the example illustrated in FIG. 13 indicates a case in which the processing throughput indicated by the node ID “3” is “30”. Furthermore, the example illustrated in FIG. 13 indicates a case in which the processing throughput indicated by the node ID “4” is “45”. Furthermore, the example illustrated in FIG. 13 indicates a case in which the processing throughput indicated by the node ID “5” is “1000”.

If the association relationships illustrated in FIGS. 12 and 13 are stored in the internal memory in the parental generation selecting unit 6c, for the parental generation illustrated in FIG. 5, when the number of nodes in which the processing load exceeds the processing throughput is calculated, the parental generation selecting unit 6c performs the following process. For example, in the example illustrated in FIG. 5, because the instance indicated by the instance ID “1” and the instance indicated by the instance ID “4” are arranged in the node indicated by the node ID “1”, the parental generation selecting unit 6c determines whether the sum of the processing load L (1) and the processing load L (4) exceeds the processing throughput P (1). Because the processing load L (1) is “10”, because the processing load L (4) is “15”, and because the processing throughput P (1) is “30”, the parental generation selecting unit 6c determines that the sum of the processing load L (1) and the processing load L (4) does not exceed the processing throughput P (1).

Furthermore, in the example illustrated in FIG. 5, because the instance indicated by the instance ID “2” is arranged in the node indicated by the node ID “2”, the parental generation selecting unit 6c determines whether the processing load L (2) exceeds the processing throughput P (2). Because the processing load L (2) is “10” and the processing throughput P (2) is “30”, the parental generation selecting unit 6c determines that the processing load L (2) does not exceed the processing throughput P (2).

Furthermore, in the example illustrated in FIG. 5, because the instance indicated by the instance ID “3” is arranged in the node indicated by the node ID “3”, the parental generation selecting unit 6c determines whether the processing load L (3) exceeds the processing throughput P (3). Because the processing load L (3) is “10” and the processing throughput P (3) is “30”, the parental generation selecting unit 6c determines that the processing load L (3) does not exceed the processing throughput P (3).

Furthermore, in the example illustrated in FIG. 5, because the instance indicated by the instance ID “5” is arranged in the node indicated by the node ID “4”, the parental generation selecting unit 6c determines whether the processing load L (5) exceeds the processing throughput P (4). Because the processing load L (5) is “15” and the processing throughput P (4) is “45”, the parental generation selecting unit 6c determines that the processing load L (5) does not exceed the processing throughput P (4).

Furthermore, in the example illustrated in FIG. 5, because each of the instances indicated by one of the instance IDs “6”, “7”, and “8” is arranged in the node indicated by the node ID “5”, the parental generation selecting unit 6c performs the following process. Namely, the parental generation selecting unit 6c determines whether the sum of the processing load L (6), the processing load L (7), and the processing load L (8) exceeds the processing throughput P (5). At this point, because the processing load L (6), the processing load L (7), and the processing load L (8) are “20” and the processing throughput P (5) is “1000”, the parental generation selecting unit 6c determines that the sum of the processing load L(6), the processing load L(7), and the processing load (8) does not exceed the processing throughput P (5).

As described above, the number of nodes in which the processing load exceeds the processing throughput is “0”. Accordingly, if the association relationships illustrated in the examples in FIGS. 12 and 13 are stored in the internal memory, the parental generation selecting unit 6c calculates, for the parental generation illustrated in the example in FIG. 5, the number of nodes “0” in which the processing load exceeds the processing throughput.

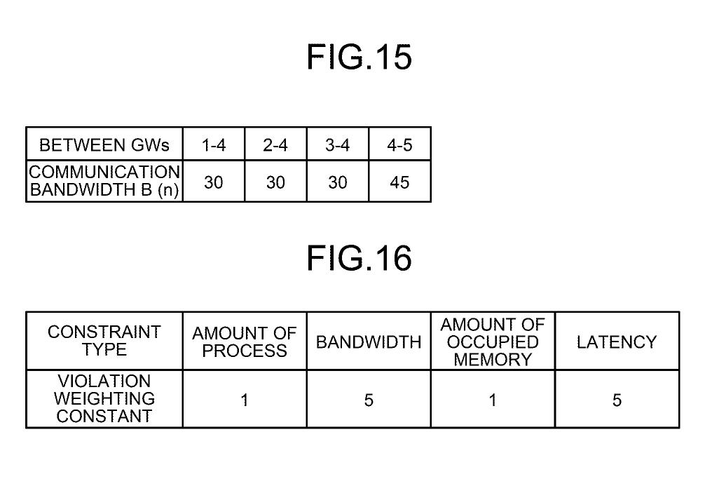

In the following, an example of a method for calculating the number of paths in which the communication traffic exceeds the communication bandwidth when an instance is executed will be described with reference to FIGS. 14 and 15. FIG. 14 illustrates an example of the association relationship the concatenation ID that is used to identify the instances concatenated two instance IDs for the instances by using the symbol “−” and the communication traffic between the instances indicated by the concatenation ID. The communication traffic can be obtained by, for example, extracting a communication traffic monitor running in a node, by measuring the communication traffic by an emulator at the time of virtual operation, or by calculating from an input/output prospect function defined for each instance. The association relationship between the concatenation ID and the communication traffic described above is stored, in advance, in the internal memory in the parental generation selecting unit 6c.

The communication traffic T (i) illustrated in FIG. 14 indicates the communication traffic between the instances indicated by the concatenation ID “i”. For example, the example illustrated in FIG. 14 indicates a case in which the communication traffic, i.e., the communication traffic of the event flowing from the instance indicated by the instance ID “1” to the instance indicated by the instance ID “4”, between the instances indicated by the concatenation ID “1-4” is “30”.

Furthermore, the example illustrated in FIG. 14 indicates a case in which the communication traffic, i.e., the communication traffic of the event flowing from the instance indicated by the instance ID “2” to the instance indicated by the instance ID “5”, between the instances indicated by the concatenation ID “2-5” is “30”.

Furthermore, the example illustrated in FIG. 14 indicates a case in which the communication traffic, i.e., the communication traffic of the event flowing from the instance indicated by the instance ID “3” to the instance indicated by the instance ID “5”, between the instances indicated by the concatenation ID “3-5” is “30”.

Furthermore, the example illustrated in FIG. 14 indicates a case in which the communication traffic, i.e., the communication traffic of the event flowing from the instance indicated by the instance ID “4” to the instance indicated by the instance ID “6”, between the instances indicated by the concatenation IDs “4-6” is “5”.

Furthermore, the example illustrated in FIG. 14 indicates a case in which the communication traffic, i.e., the communication traffic of the event flowing from the instance indicated by the instance ID “4” to the instance indicated by the instance ID “7”, between the instances indicated by the concatenation ID “4-7” is “5”.

Furthermore, the example illustrated in FIG. 14 indicates a case in which the communication traffic, i.e., the communication traffic of the event flowing from the instance indicated by the instance ID “5” to the instance indicated by the instance ID “6”, between the instances indicated by the concatenation ID “5-6” is “5”.

Furthermore, the example illustrated in FIG. 14 indicates a case in which the communication traffic, i.e., the communication traffic of the event flowing from the instance indicated by the instance ID “5” to the instance indicated by the instance ID “7”, between the instances indicated by the concatenation ID “5-7” is “ ”5”.

Furthermore, the example illustrated in FIG. 14 indicates a case in which the communication traffic, i.e., the communication traffic of the event flowing from the instance indicated by the instance ID “5” to the instance indicated by the instance ID “8”, between the instances indicated by the concatenation ID “5-8” is “1”.

FIG. 15 illustrates an example of the association relationship between the concatenation ID that is used to identify a path between the nodes and that is indicated by two node IDs for the nodes by using the symbol “−” and the communication bandwidth of the path between the nodes indicated by the concatenation ID. The communication bandwidth can be obtained from, for example, a data transfer test. The association relationship between the concatenation ID and the communication bandwidth described above is stored, in advance, in the internal memory in the parental generation selecting unit 6c.

The communication bandwidth B (n) illustrated in FIG. 15 indicates the communication bandwidth for the path between the nodes indicated by the concatenation ID “n”. For example, the example illustrated in FIG. 15 indicates a case in which the communication bandwidth for the path between the node indicated by the node ID “1” and the node indicated by the node ID “4”, which are indicated by the concatenation ID “1-4”, is “30”. Furthermore, the example illustrated in FIG. 15 indicates a case in which the communication bandwidth for the path between the node indicated by the node ID “2” and the node indicated by the node ID “4”, which are indicated by the concatenation ID “2-4”, is “30”. Furthermore, the example illustrated in FIG. 15 indicates a case in which the communication bandwidth for the path between the node indicated by the node ID “3” and the node indicated by the node ID “4”, which are indicated by the concatenation ID “3-4”, is “30”. Furthermore, the example illustrated in FIG. 15 indicates a case in which the communication bandwidth for the path between the node indicated by the node ID “4” and the node indicated by the node ID “5”, which are indicated by the concatenation ID “4-5” is “45”.

If the association relationships illustrated in FIGS. 14 and 15 are stored in the internal memory in the parental generation selecting unit 6c, when the number of paths in which the communication traffic exceeds the communication bandwidth is calculated for the parental generation illustrated in FIG. 5, the parental generation selecting unit 6c performs the following process. For example, in the example illustrated in FIG. 5, as in the example illustrated in FIG. 6, the event flows from the instance indicated by the instance ID “4” to the instance indicated by the instance ID “6” in the path between the node indicated by the node ID “1” and the node indicated by the node ID “4”. Consequently, the parental generation selecting unit 6c determines whether the communication traffic T (4-6) exceeds the communication bandwidth B (1-4). Because the communication traffic T (4-6) is “5” and the communication bandwidth B (1-4) is “30”, the parental generation selecting unit 6c determines that the communication traffic T (4-6) does not exceed the communication bandwidth B (1-4). Furthermore, in the example illustrated in FIG. 5, as in the example illustrated in FIG. 6, the instance indicated by the instance ID “1” and the instance indicated by the instance ID “4” are arranged in the same node. Consequently, the communication between the instance indicated by the instance ID “1” and the instance indicated by the instance ID “4” is not performed between nodes via the path.

Furthermore, in the example illustrated in FIG. 5, as in the example illustrated in FIG. 6, an event flows from the instance indicated by the instance ID “2” to the instance indicated by the instance ID “5” in the path between the node indicated by the node ID “2” and the node indicated by the node ID “4”. Consequently, the parental generation selecting unit 6c determines whether the communication traffic T (2-5) exceeds the communication bandwidth B (2-4). Because the communication traffic T (2-5) is “30” and the communication bandwidth B (2-4) is “30”, the parental generation selecting unit 6c determines that the communication traffic T (2-5) does not exceed the communication bandwidth B (2-4).

Furthermore, in the example illustrated in FIG. 5, as in the example illustrated in FIG. 6, an event flows from the instance indicated by the instance ID “3” to the instance indicated by the instance ID “5” in the path between the node indicated by the node ID “3” and the node indicated by the node ID “4”. Consequently, the parental generation selecting unit 6c determines whether the communication traffic T (3-5) exceeds the communication bandwidth B (3-4). Because the communication traffic T (3-5) is “30” and the communication bandwidth B (3-4) is “30”, the parental generation selecting unit 6c determines that the communication traffic T (3-5) does not exceed the communication bandwidth B (3-4).

Furthermore, in the example illustrated in FIG. 5, as in the example illustrated in FIG. 6, an event flows from the instance indicated by the instance ID “4” to the instance indicated by the instance ID “6” in the path between the node indicated by the node ID “4” and the node indicated by the node ID “5”. Furthermore, in the example illustrated in FIG. 5, as in the example illustrated in FIG. 6, an event flows from the instance indicated by the instance ID “4” to the instance indicated by the instance ID “7” in the path between the node indicated by the node ID “4” and the node indicated by the node ID “5”. Furthermore, in the example illustrated in FIG. 5, as in the example illustrated in FIG. 6, an event flows from the instance indicated by the instance ID “5” to the instance indicated by the instance ID “6” in the path between the node indicated by the node ID “4” and the node indicated by the node ID “5”. Furthermore, in the example illustrated in FIG. 5, as in the example illustrated in FIG. 6, an event flows from the instance indicated by the instance ID “5” to the instance indicated by the instance ID “7” in the path between the node indicated by the node ID “4” and the node indicated by the node ID “5”. Consequently, the parental generation selecting unit 6c determines whether the sum of the communication traffic T (4-6), the communication traffic T (4-7), the communication traffic T (5-6), and the communication traffic T (5-7) exceeds the communication bandwidth B (4-5). Because each of the communication traffic T (4-6), the communication traffic T (4-7), the communication traffic T (5-6), and the communication traffic T (5-7) is “5” and the communication bandwidth B (4-5) is “45”, the parental generation selecting unit 6c determines that the sum of the communication traffic T (4-6), the communication traffic T (4-7), the communication traffic T (5-6), and the communication traffic T (5-7), which is “20”, does not exceed the communication bandwidth B (4-5). Furthermore, in the example illustrated in FIG. 5, as in the example illustrated in FIG. 6, the instance indicated by the instance ID “6” and the instance indicated by the instance ID “8” are arranged in the same node. Consequently, the communication between the instance indicated by the instance ID “6” and the instance indicated by the instance ID “8” is not performed between nodes via the path.

As described above, the number of paths in which the communication traffic exceeds the communication bandwidth obtained when the instances are executed is “0”. Accordingly, if the association relationships illustrated in the examples in FIGS. 14 and 15 are stored in the internal memory, the parental generation selecting unit 6c calculates, for the parental generation illustrated in the example in FIG. 5, the number of paths in which the communication traffic exceeds the communication bandwidth, i.e., “0”, obtained when the instances are executed.

Then, the parental generation selecting unit 6c calculates, as a constraint evaluation value, the sum of the number of nodes, i.e., “0”, in which the processing load exceeds the processing throughput, i.e., “0”, and the number of paths in which the communication traffic exceeds the communication bandwidth, i.e., “0”.

Furthermore, the parental generation selecting unit 6c may also calculate, as a constraint evaluation value, a value obtained by weighting, by using a predetermined weighting constant, the number of nodes in which the processing load exceeds the processing throughput and the number of paths in which the communication traffic exceeds the communication bandwidth. In the following, the predetermined weighting constant will be described. FIG. 16 is a schematic diagram illustrating an example of a predetermined weighting constant. The example illustrated in FIG. 16 indicates a case in which the weighting constant of the number of nodes in which the processing load exceeds the processing throughput is “1” and the weighting constant of the number of paths in which the communication traffic exceeds the communication bandwidth is “5”. At this point, for the node in which the processing load exceeds the processing throughput, by moving an event to the peripheral node, the processing load can be easily set such that the processing load does not exceed the processing throughput. However, for the path in which the communication traffic exceeds the communication bandwidth, by performing a complicated process, such as arranging an instance subjected to a high compression process or arranging, when an alternative path is present, an instance in a node in the alternative path, the communication traffic can be set such that the communication traffic does not exceed the communication bandwidth. Accordingly, for the path in which the communication traffic exceeds the communication bandwidth, when a solution is changed in order such that the communication traffic does not exceed the communication bandwidth, the solution is significantly changed when compared in a case in which, for the node in which the processing load exceeds the processing throughput, a solution is changed in order such that the processing load does not exceed the processing throughput. Specifically, for the path in which the communication traffic exceeds the communication bandwidth, it is difficult to set the communication traffic such that the communication traffic does not exceed the communication bandwidth when compared in a case in which, for the node in which the processing load exceeds the processing throughput, the processing load is set such that the processing load does not exceed the processing throughput. Accordingly, in the embodiment, by making the weighting constant of the number of paths in which the communication traffic exceeds the communication bandwidth greater than the weighting constant of the number of nodes in which the processing load exceeds the processing throughput, the number of violations in which the communication traffic exceeds the communication bandwidth is made small.

Furthermore, the parental generation selecting unit 6c may also calculate a constraint evaluation value by using another method as described below. For example, first, the parental generation selecting unit 6c calculates the number of nodes in which the usage of a memory when an instance arranged in the corresponding node exceeds the capacity of the memory in the corresponding node. Then, the parental generation selecting unit 6c calculates the number of instances in which the communication latency obtained when the instance is executed exceeds the latency that is determined for each instance. Then, the parental generation selecting unit 6c calculates, as a constraint evaluation value, the sum of the calculated number of nodes and the calculated number of instances.

Furthermore, the parental generation selecting unit 6c may also calculate a constraint evaluation value by weighting the number of nodes in which the usage of the memory described above exceeds the capacity of the memory in a corresponding node and by weighting the number of instances in which the communication latency exceeds the latency that is determined for each instance. The weighting constant that is used at this time is, for example, as illustrated in FIG. 16, “1” for the number of nodes in which the usage of the memory described above exceeds the capacity of the memory in the corresponding node. Furthermore, for the instance in which the communication latency exceeds the latency that is determined for each instance, the weighting constant is “5”. The reason the weighting constant differs, such as “1” and “5”, is the same as that described above: the weighting constant of the number of nodes in which the processing load exceeds the processing throughput is different from the weighting constant of the number of path in which the communication traffic exceeds the communication bandwidth.

Then, the parental generation selecting unit 6c selects, as a parental generation from among the two parental generations and the two next generations, the top two generations that are indicated by the constraint evaluation value and in which the number of violations of the constraint is small. For example, when the parental generation selecting unit 6c calculates, as a constraint evaluation value, the sum of the number of nodes in which the processing load exceeds the processing throughput and the number of paths in which the communication traffic exceeds the communication bandwidth, the number of violations of the constraint is decreased as the sum value is smaller. Accordingly, the parental generation selecting unit 6c selects, from among the two parental generations and the two next generations, the top two generations with a small constraint evaluation value as new parental generations. Then, the parental generation selecting unit 6c stores the two new parental generations in the parental generation storing unit 5b and updates the two parental generations stored in the parental generation storing unit 5b.

Furthermore, if the value of the flag that is referred to is “3”, the parental generation selecting unit 6c calculates, similarly to the case in which the value of the flag that is referred to is “1”, the evaluation value, which has been described above, for the two parental generations and the two next generations. Furthermore, if the value of the flag that is referred to is “3”, the parental generation selecting unit 6c calculates, similarly to the case in which the value of the flag that is referred to is “2”, the constraint evaluation value, which has been described above, for the two parental generations and the two next generations.

Then, the parental generation selecting unit 6c calculates the sum of the evaluation value and the constraint evaluation value as a new evaluation value. Then, the parental generation selecting unit 6c selects, as new parental generations, the top two generations with the highest evaluation that is indicated by the new evaluation values. For example, if evaluation increases as the new evaluation value decreases, the parental generation selecting unit 6c selects the top two generations with the new low evaluation value as the new parental generations. Then, the parental generation selecting unit 6c stores the two new parental generations in the parental generation storing unit 5b and updates the two parental generations stored in the parental generation storing unit 5b.

Furthermore, the parental generation selecting unit 6c may also calculate a new evaluation value by performing a predetermined weighting on the evaluation value and the constraint evaluation value and select, from among the two parental generations and the two next generations, the top two generations with the highest evaluation that is indicated by the calculated evaluation value as the new parental generations.

Furthermore, the parental generation selecting unit 6c may also specify, from among the two parental generations and the two next generations, the generations in which the number of violations of the constraint that is indicated by the constraint evaluation value is equal to or less than a predetermined value (for example, 3) and may also select the top two generation with the highest evaluation that is indicated by the evaluation values as the new parental generations.

As described above, after storing the new parental generations in the parental generation storing unit 5b when the value of the flag that is referred to is either one of “1”, “2”, and “3”, the parental generation selecting unit 6c determines whether an end condition is satisfied. For example, the parental generation selecting unit 6c determines whether the new parental generations are updated a predetermined number of times or more. If the new parental generations are updated the predetermined number of times, the parental generation selecting unit 6c determines that the end condition is satisfied. In contrast, if the new parental generations are not updated the predetermined number of times, the parental generation selecting unit 6c determines that the end condition is not satisfied. The parental generation selecting unit 6c determines, during the time period for which the new parental generations are being updated the predetermined number of times or more, an optimum solution, which will be described later, is updated. If the optimum solution is updated, the parental generation selecting unit 6c may determine that the end condition is not satisfied. In contrast, if the optimum solution is not updated, the parental generation selecting unit 6c may determine that the end condition is satisfied.

The mode determining unit 6d determines a mode used in a modular arrangement decision process. In the following, the mode determining unit 6d will be described. If the parental generation selecting unit 6c determines that the end condition is not satisfied, the mode determining unit 6d, first, refers to the value of the flag stored in the flag storing unit 5g. Then, by determining whether the value of the flag that is referred to is “2”, the mode determining unit 6d determines whether the mode in the modular arrangement decision process is a constraint search.

If it is determined that the mode in the modular arrangement decision process is a constraint search, the mode determining unit 6d acquires the two parental generations stored in the parental generation storing unit 5b. Then, the mode determining unit 6d determines, for the acquired two parental generations, whether the number of violations of the constraint that is indicated by the constraint evaluation value is 0. If it is determined, for both the two parental generations, the number of violations of the constraint that is indicated by the constraint evaluation value is 0, the mode determining unit 6d updates the value of the flag stored in the flag storing unit 5g to “3” and sets the mode used in the modular arrangement decision process to the peripheral search mode.

In contrast, if it is determined that the mode in the modular arrangement decision process is not the constraint search mode, the mode determining unit 6d determines, during the time period for which the next generations are being updated the predetermined number of times or more, whether the parental generations are updated. During the time period for which the next generations are being updated the predetermined number of times or more, if it is determined that the parental generations are not updated the predetermined number of times, the mode determining unit 6d determines, by determining whether the value of the flag that is referred to is “1”, whether the mode in the modular arrangement decision process is the global search mode. If it is determined that the mode is the global search mode, the mode determining unit 6d updates the value of the flag stored in the flag storing unit 5g to “2” and sets the mode in the modular arrangement decision process to the constraint search mode.

Furthermore, if it is determined that the mode is not the global search mode, the mode in the modular arrangement decision process is the peripheral search mode. In this case, the mode determining unit 6d updates the value of the flag stored in the flag storing unit 5g to “1” and sets the mode in the modular arrangement decision process to the global search. Furthermore, if the optimum solution updating unit 6e updates the optimum solution, or, if it is determined that the number of violations of the constraint that is indicated by the constraint evaluation value is zero in the two parental generations and if it is determined that the parental generation with the evaluation higher than that of the current optimum solution (the evaluation value is low) is not present, the mode determining unit 6d performs the following process. Namely, the mode determining unit 6d acquires the two parental generations stored in the parental generation storing unit 5b, mutates each of the acquired parental generations, and creates new two parental generations. Then, the mode determining unit 6d stores the two new parental generations in the parental generation storing unit 5b and updates the two parental generations stored in the parental generation storing unit 5b.

The optimum solution updating unit 6e updates an optimum solution. In the following, the optimum solution updating unit 6e will be described. For example, if the mode determining unit 6d updates the value of the flag stored in the flag storing unit 5g to “1” and the mode in the modular arrangement decision process is set to the global search, the optimum solution updating unit 6e performs the following process. Namely, the optimum solution updating unit 6e acquires the two parental generations stored in the parental generation storing unit 5b. Then, the optimum solution updating unit 6e determines whether the number of violations of the constraint that is indicated by the constraint evaluation value is zero and a parental generation with the evaluation that is higher than that of the optimum solution stored in the optimum solution storing unit 5a is present in the acquired two parental generations.

If it is determined that the number of violations of the constraint that is indicated by the constraint evaluation value is zero and a parental generation with the evaluation that is higher than that of the optimum solution stored in the optimum solution storing unit 5a is present in the acquired two parental generations, the optimum solution updating unit 6e performs the following process. Namely, the optimum solution updating unit 6e stores, as the optimum solution in the optimum solution storing unit 5a, the parental generation in which the number of violations of the constraint is zero and which have the evaluation higher than the optimum solution stored in the optimum solution storing unit 5a and then updates the optimum solution stored in the optimum solution storing unit 5a.

The optimum solution output control unit 6f performs control such that an optimum solution is output. In the following, the optimum solution output control unit 6f will be described. If the parental generation selecting unit 6c determines that the end condition is not satisfied, the optimum solution output control unit 6f acquires the optimum solution stored in the optimum solution storing unit 5a and controls the output unit 3 such that the acquired optimum solution is displayed. Consequently, the optimum solution is displayed on the output unit 3.

The module output control unit 6g performs control such that an instance is output to a lower level node. In the following, the module output control unit 6g will be described. If an instruction to arrange an instance in a node in a manner indicated by an optimum solution is input from the input unit 2, the module output control unit 6g acquires the optimum solution from the optimum solution storing unit 5a. Then, the module output control unit 6g acquires all of the instances from the module storing unit 5e. Then, the module output control unit 6g sends, to the communication unit 4, an instruction to send the instance to the node in accordance with the indicated optimum solution. Consequently, the communication unit 4 sends the instance to the node in a manner indicated by the optimum solution. Furthermore, each of the nodes that receive the instance arranges the received instance in the corresponding node.

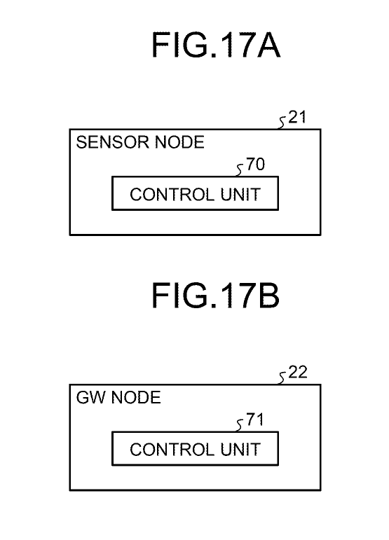

In the following the functional configuration of the sensor node 21 will be described. FIG. 17A is a block diagram illustrating an example of the functional configuration of a sensor node according to the embodiment. As illustrated in FIG. 17A, the sensor node 21 includes a control unit 70. The control unit 70 sends, as an event to the server node 1 via the GW node 22 and the network 23, data subjected to sensing by the sensor mounted on the sensor node 21. Furthermore, when the control unit 70 receives an instance sent from the server node 1, the control unit 70 arranges the received instance in its own node. Consequently, the control unit 70 can execute the received instance.

Then, the functional configuration of the GW node 22 will be described. FIG. 17B is a block diagram illustrating an example of the functional configuration of a GW node according to the embodiment. As illustrated in FIG. 17B, the GW node 22 includes a control unit 71. When the control unit 71 receives an event sent from the sensor node 21, the control unit 71 sends the received event to the server node 1 via the network 23. Furthermore, when the control unit 71 receives an instance sent from the server node 1, the control unit 71 arranges the received instance in its own node. Consequently, the control unit 71 executes the received instance.

Flow of a Process

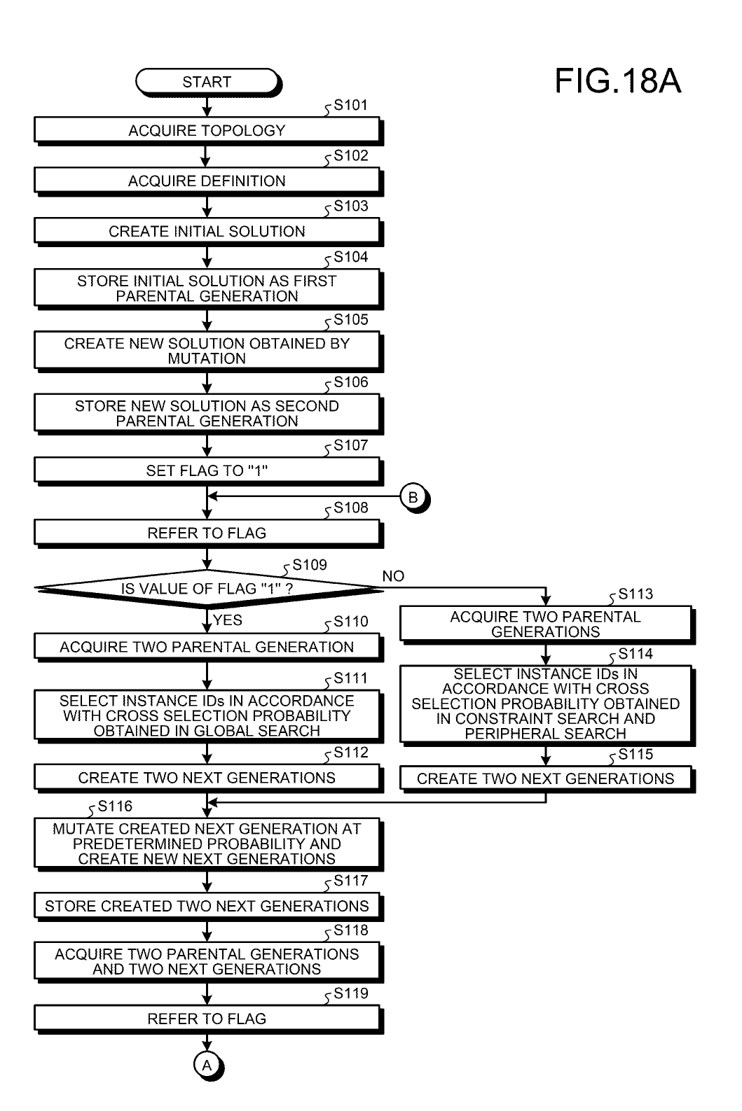

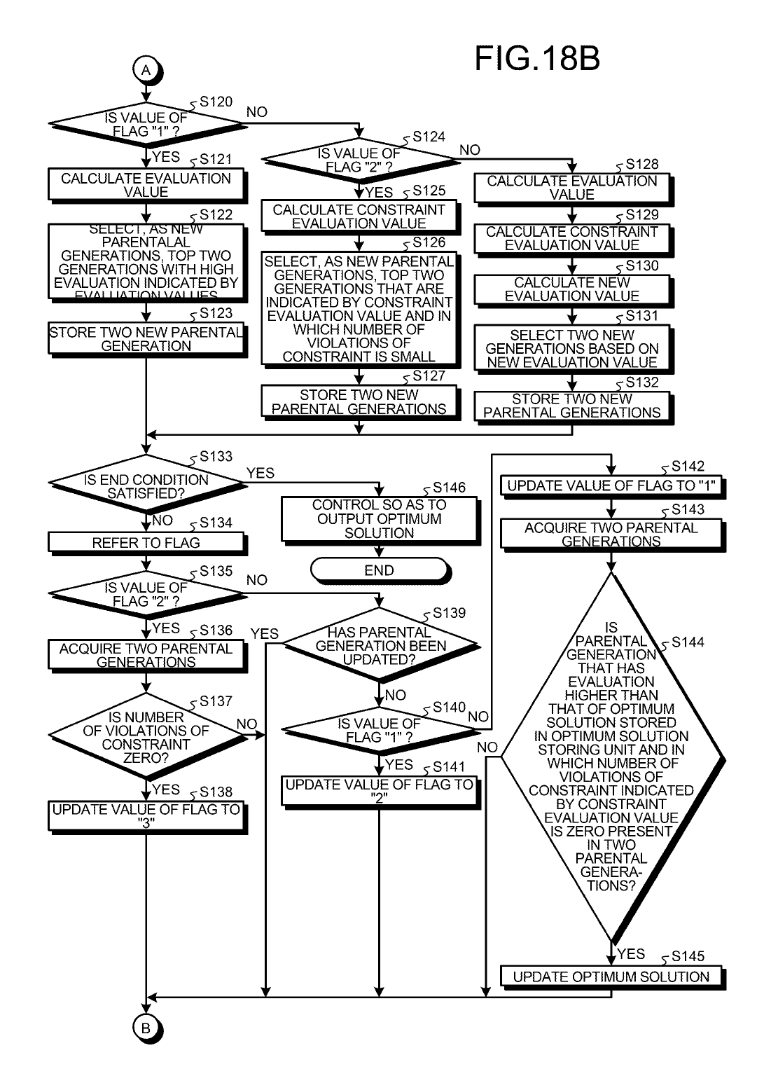

In the following, a description will be given of the flow of a modular arrangement decision process executed by the server node 1 according to the embodiment. FIGS. 18A and 18B are flowcharts each illustrating the flow of a modular arrangement decision process according to the embodiment. The modular arrangement decision process according to the embodiment is executed by the control unit 6 when the control unit 6 receives, for example, an instruction to execute the modular arrangement decision process as an input from the input unit 2.

As illustrated in FIG. 18A, the initial solution creating unit 6a acquires the topology from the topology storing unit 5d (Step S101). Then, the initial solution creating unit 6a acquires the definition stored in the module definition storing unit 5f from the module definition storing unit 5f (Step S102).

Then, the initial solution creating unit 6a creates an initial solution (Step S103). Then, the initial solution creating unit 6a stores the created solution in the parental generation storing unit 5b as a first parental generation (Step S104).

Then, by using the genetic algorithm, the initial solution creating unit 6a creates, from the first parental generation, a new solution due to the mutation (Step S105). Then, the initial solution creating unit 6a stores the created solution in the parental generation storing unit 5b as a second parental generation (Step S106).

Then, the initial solution creating unit 6a sets the flag stored in the flag storing unit 5g to “1” (Step S107). Then, the next generation creating unit 6b refers to the flag stored in the flag storing unit 5g (Step S108).

Then the next generation creating unit 6b determines whether the value of the flag is “1” (Step S109). If the value of the flag is “1” (Yes at Step S109), the next generation creating unit 6b acquires two parental generations stored in the parental generation storing unit 5b (Step S110). Then, the next generation creating unit 6b selects the instance IDs of the two parental generations by a predetermined number of crosses (for example, “3”) in accordance with a probability (cross selection probability) of selecting each of the instance IDs indicated by the probability information obtained in the global search (Step S111).

By interchanging the node ID associated with the selected instance ID in one parental generation with the node ID associated with the selected instance ID in the other parental generation, the next generation creating unit 6b crosses the two parental generations and creates two next generations (Step S112).

If the value of the flag is not “1” (No at Step S109), i.e., the value of the flag is “2” or “3”, the next generation creating unit 6b acquires two parental generations stored in the parental generation storing unit 5b (Step S113). Then, the next generation creating unit 6b selects the instance IDs of the two parental generations by the predetermined number of crosses (for example, “3”) in accordance with a probability (cross selection probability) of selecting each of the instance IDs indicated by the probability information when the constraint search or the peripheral search is performed (Step S114).

By interchanging the node ID associated with the selected instance ID in one parental generation with the node ID associated with the selected instance ID in the other parental generation, the next generation creating unit 6b crosses the two parental generations and creates two next generations (Step S115).

Then, the next generation creating unit 6b mutates the created next generations at a predetermined probability (0.1% to 5%) and creates new next generations (Step S116).

Then, the next generation creating unit 6b stores the created two next generations in the next generation storing unit 5c (S117). If the two next generations have already been stored in the next generation storing unit 5c, the next generation creating unit 6b updates the two next generations that have already been stored in the next generation storing unit 5c to the created two next generations.

Then, the parental generation selecting unit 6c acquires the two parental generations stored in the parental generation storing unit 5b and the two next generations stored in the next generation storing unit 5c (Step S118). Then, the parental generation selecting unit 6c refers to the flag stored in the flag storing unit 5g (Step S119).

Then, as illustrated in FIG. 18B, the parental generation selecting unit 6c determines whether the value of the flag is “1” (Step S120). If the value of the flag is “1” (Yes at Step S120), for each of the two parental generations, the parental generation selecting unit 6c arranges an instance in a node as indicated by the parental generation and calculates an evaluation value that is used when the node executes the instance. Furthermore, for each of the two next generations, the parental generation selecting unit 6c arranges an instance in a node as indicated by the next generation and calculates an evaluation value that is used when the node executes the instance (Step S121).

Then, the parental generation selecting unit 6c selects, as new parental generations from among the two parental generations and the two next generations, the top two generations with the highest evaluation indicated by the evaluation values (Step S122). Then, the parental generation selecting unit 6c stores the two new parental generations in the parental generation storing unit 5b and updates the two parental generations stored in the parental generation storing unit 5b (Step S123).

In contrast, if the value of the flag is not “1” (No at Step S120), the parental generation selecting unit 6c determines whether the value of the flag is “2” (Step S124). If the value of the flag is “2” (Yes at Step S124), the parental generation selecting unit 6c arranges a module in a node as indicated by the parental generation and calculates, for each of the two next generations, a constraint evaluation value that is used when the node executes the instance. Furthermore, for each of the two next generations, the parental generation selecting unit 6c arranges a module in a node as indicated by the next generation and calculates a constraint evaluation value that is used when the node executes the instance (Step S125).

Then, the parental generation selecting unit 6c selects, as parental generations from among the two parental generations and the two next generations, the top two generations that are indicated by the constraint evaluation value and in which the number of violations of the constraint is small (Step S126). Then, the parental generation selecting unit 6c stores the two new parental generations in the parental generation storing unit 5b and updates the two parental generations stored in the parental generation storing unit 5b (Step S127).

In contrast, if the value of the flag is not “2” (No at Step S124), i.e., the value of the flag is “3”, the parental generation selecting unit 6c performs the following process. Namely, similarly to the case in which the value of the flag that is referred to is “1”, the parental generation selecting unit 6c calculates the evaluation value, which has been described above, for each of the two parental generations and the two next generations (Step S128). Furthermore, similarly to the case in which the value of the flag that is referred to is “2”, the parental generation selecting unit 6c calculates the constraint evaluation value, which has been described above, for each of the two parental generations and the two next generations (Step S129).

Then, the parental generation selecting unit 6c calculates new evaluation values from the evaluation value and the constraint evaluation value (Step S130). Then, the parental generation selecting unit 6c selects, as new parental generations, the top two generations having the highest evaluation that is indicated by the new evaluation values (Step S131). Then, the parental generation selecting unit 6c stores the two new parental generations in the parental generation storing unit 5b and updates the two parental generations stored in the parental generation storing unit 5b (Step S132).

Then, the parental generation selecting unit 6c determines whether the end condition described above is satisfied (Step S133). If the end condition is not satisfied (No at Step S133), the mode determining unit 6d refers to the value of the flag stored in the flag storing unit 5g (Step S134). By determining whether the value of the flag that is referred to is “2”, the mode determining unit 6d determines whether the mode in the modular arrangement decision process is the constraint search (Step S135).

If the mode is the constraint search (Yes at Step S135), the mode determining unit 6d acquires two parental generations stored in the parental generation storing unit 5b (Step S136). Then, the mode determining unit 6d determines, for the acquired two parental generations, whether the number of violations of the constraint that is indicated by the constraint evaluation value is zero (Step S137). If the number of violations of the constraint that is indicated by the constraint evaluation value is 0 for these two parental generations (Yes Step S137), the mode determining unit 6d performs the following process. Namely, the mode determining unit 6d updates the value of the flag stored in the flag storing unit 5g to “3”, sets the mode in the modular arrangement decision process to the peripheral search mode (Step S138), and then returns to Step S108. Furthermore, in a case in which the number of violations of the constraint that is indicated by the constraint evaluation value for at least one parental generation out of the two parental generations is not zero (No at Step S137), the mode determining unit 6d also returns to Step S108.

In contrast, if the mode is not the constraint search (No at Step S135), when the next generation is being updated a predetermined number of times or more, the mode determining unit 6d determines whether the parental generation has been updated (Step S139). When the next generation is being updated the predetermined number of times or more, if the parental generation is not updated (No at Step S139), the mode determining unit 6d performs the following process. Namely, by determining whether the value of the flag that is referred to is “1”, the mode determining unit 6d determines whether the mode in the modular arrangement decision process is the global search (Step S140). If the mode is the global search (Yes at Step S140), the mode determining unit 6d updates the value of the flag stored in the flag storing unit 5g to “2”, sets the mode in the modular arrangement decision process to the constraint search mode (Step S141), and then returns to Step S108.

Furthermore, when the next generation is being updated the predetermined number of times, if the parental generation is updated (Yes at Step S139), the mode determining unit 6d returns to Step S108.

Furthermore, if the mode is not the global search (No at Step S140), the mode determining unit 6d updates the value of the flag stored in the flag storing unit 5g to “1” and sets the mode in the modular arrangement decision process to the global search (Step S142). Then, the optimum solution updating unit 6e acquires the two parental generations stored in the parental generation storing unit 5b (Step S143). Then, the optimum solution updating unit 6e determines whether a parent generation that has evaluation higher than that of the optimum solution stored in the optimum solution storing unit 5a and in which the number of violations of the constraint indicated by the constraint evaluation value is zero is present in the acquired two parental generations (Step S144).

If a parent generation that has evaluation higher than that of the optimum solution stored in the optimum solution storing unit 5a and in which the number of violations of the constraint indicated by the constraint evaluation value is zero is present in the acquired two parental generations (Yes Step S144), the optimum solution updating unit 6e performs the following process. Namely, the optimum solution updating unit 6e stores, as the optimum solution in the optimum solution storing unit 5a, the parental generation that has evaluation higher than that of the optimum solution stored in the optimum solution storing unit 5a and in which the number of violations of the constraint indicated by the constraint evaluation value is zero and updates the optimum solution stored in the optimum solution storing unit 5a (Step S145). Then, the optimum solution updating unit 6e returns to Step S108.

In contrast, if a parent generation that has evaluation higher than that of the optimum solution stored in the optimum solution storing unit 5a and in which the number of violations of the constraint indicated by the constraint evaluation value is zero is not present in the acquired two parental generations (No at Step S144), the optimum solution updating unit 6e returns to Step S108.

Furthermore, if the end condition is not satisfied (No at Step S133), the optimum solution output control unit 6f acquires the optimum solution stored in the optimum solution storing unit 5a, controls the output unit 3 so as to display the acquired optimum solution (Step S146), and ends the modular arrangement decision process.

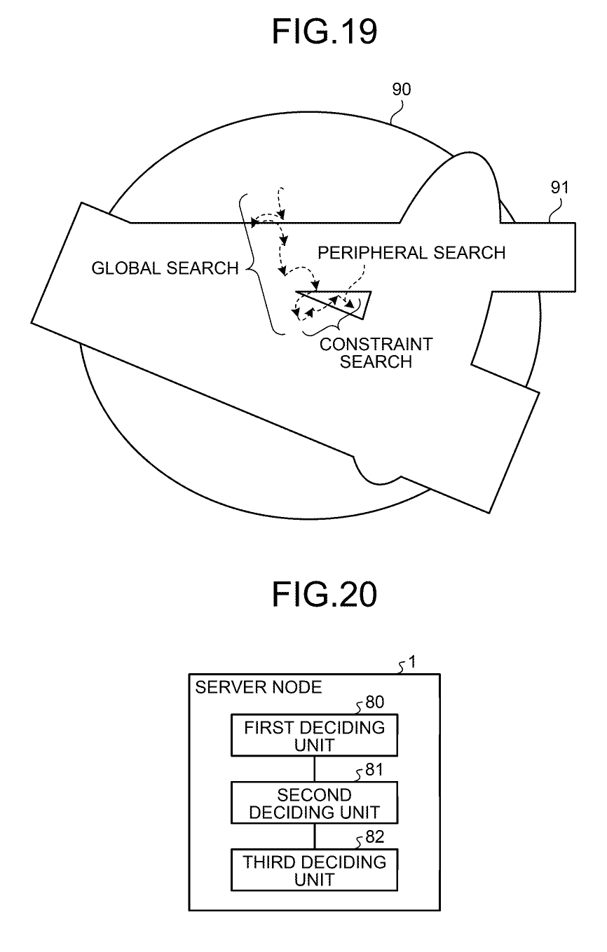

FIG. 19 is a schematic diagram illustrating an example of a process performed by the server node according to the embodiment. The example illustrated in FIG. 19 indicates a case in which the evaluation value is decreased (evaluation is increased) as a solution of each of the parental generation and the next generation is located away from the center of an area 90. The evaluation value in which evaluation increases as an evaluation value decreases and evaluation decreases as an evaluation value increases is, for example, a value of a cost. This kind of evaluation value is also referred to as a cost evaluation value. Furthermore, in the example illustrated in FIG. 19, a constraint area 91 indicates an area in which the number of violations of the constraint is equal to or greater than zero. If a solution is present in this area, this indicates the violation of the constraint. As indicated by the example illustrated in FIG. 19, the server node 1 sequentially creates, on the basis of the evaluation value, solutions such that evaluation increases by ignoring the constraint evaluation value between the evaluation value and the constraint evaluation value in the global search mode. Then, in the constraint search mode, the server node 1 sequentially creates solutions such that the number of violations of the constraint is further decreased on the basis of the constraint evaluation value by ignoring the evaluation value between the evaluation value and the constraint evaluation value. Then, on the basis of the evaluation value and the constraint evaluation value in the peripheral search mode, the server node 1 decides an optimum solution in which the number of violations of the constraint is zero and the evaluation value is the lowest. Consequently, similarly to the conventional technology, it is possible to decide a module that is arranged in a node without calculating various evaluation values for all combinations between a lower level node and a module that processes an event arranged in the lower level node. Accordingly, with the server node 1 according to the embodiment, it is possible to easily decide which module is arranged in which node.

Furthermore, if a mode is the global search mode, the server node 1 selects an instance ID of an instance arranged on the upstream side in the flow direction of an event in the flow of the module process at a probability higher than that performed in the constraint search mode and the peripheral search mode. Then, the server node 1 creates a next generation by changing the node in which the instance that is indicated by the selected instance ID is arranged. As described above, the instance that is arranged in the node to be changed is located more upstream side in the flow direction of the event, a possibility of a significant change in an evaluation value between the parental generation and the next generation becomes high. Consequently, when the global search mode is used, the server node 1 can significantly change a solution compared when the constraint search mode or the peripheral search mode is used.

Furthermore, when the mode is the constraint search mode, the server node 1 calculates, as a constraint evaluation value, a value obtained by weighting, by using a predetermined weighting, the number of nodes in which the processing load exceeds the processing throughput and the number of paths in which the communication traffic exceeds the communication bandwidth. For example, by making the weighting constant of the number of paths, in which the communication traffic exceeds the communication bandwidth, greater than the weighting constant of the number of nodes, in which the processing load exceeds the processing throughput, the number of violations in which the communication traffic exceeds the communication bandwidth is made small with priority.

Furthermore, the server node 1 according to the embodiment includes a processing unit associated with each mode when the server node 1 is illustrated in terms of modes. FIG. 20 is a block diagram illustrating another example of the functional configuration of the server node according to the embodiment. As illustrated in the example in FIG. 20, the server node 1 includes a first deciding unit 80, a second deciding unit 81, and a third deciding unit 82. The first deciding unit 80 is a processing unit that executes each process in the global search mode. The second deciding unit 81 is a processing unit that executes each process in the constraint search mode. The third deciding unit 82 is a processing unit that executes each process in the peripheral search mode.

In the above explanation, a description has been given of the embodiment of the device according to the present invention; however, the present invention can be implemented with various kinds of embodiments other than the embodiments described above.

For example, when a mode is the peripheral search mode, if the server node 1 creates a next generation by performing mutation, the server node 1 may also perform the following process such that a parental generation is located near a next generation from the viewpoint of a constraint evaluation value. Namely, the server node 1 calculates a hop count of another node from the node in which the instance ID targeted for the mutation is arranged. Then, the server node 1 calculates, for each node, the reciprocal of the hop count of the other node as the selection priority. Then, the server node 1 calculates, for each node as the selection priority, a value obtained by dividing the selection priority by the sum of the selection priority of all of the other nodes (selection priority/sum of the selection priority of all of the other nodes). Then, the server node 1 selects another node in accordance with the selection possibility and sets the node ID of the selected node as the node ID of the node in which the instance ID targeted for the mutation is arranged. Consequently, when the mode is the peripheral search mode, the server node 1 can perform the mutation such that a parental generation and a next generation are located close each other in terms of the constraint evaluation value.

Furthermore, of the processes described in the embodiment, the whole or a part of the processes that are mentioned as being automatically performed can be manually performed. Alternatively, the whole or a part of the processes that are mentioned as being manually performed can be automatically performed using known methods.

Furthermore, the processes performed at steps described in each embodiment may be separated or integrated depending on various loads or use conditions. Furthermore, it may also be possible to omit a step.

Furthermore, the order of the processes performed at steps described in each embodiment may be changed depending on various loads or use conditions.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Modular Arrangement Decision Program

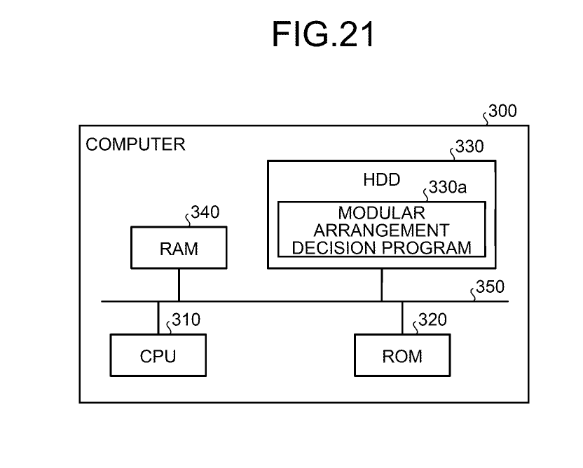

The various processes performed by the server node 1 described in the embodiment may also be implemented by a program prepared in advance and executed by a computer system such as a personal computer or a workstation. Accordingly, in the following, an example of a computer that executes a modular arrangement decision program having the same function as that performed by the server node 1 described in the embodiment will be described as an example with reference to FIG. 21. FIG. 21 is a block diagram illustrating a computer that executes a modular arrangement decision program.

As illustrated in FIG. 21, a computer 300 includes a CPU 310, a ROM 320, a hard disk drive (HDD) 330, and a RAM 340. These devices 310 to 340 are connected via a bus 350.

The ROM 320 stores therein a basic program, such as an operating system (OS). The HDD 330 stores therein, in advance, a modular arrangement decision program 330a that performs the same function as that performed by the initial solution creating unit 6a, the next generation creating unit 6b, the parental generation selecting unit 6c, the mode determining unit 6d, the optimum solution updating unit 6e, the optimum solution output control unit 6f, and the module output control unit 6g.

Then, the CPU 310 reads the modular arrangement decision program 330a from the HDD 330 and executes the modular arrangement decision program 330a.

Furthermore, the modular arrangement decision program 330a described above does not need to be stored in the HDD 330 from the beginning.

For example, the modular arrangement decision program 330a is stored in a “portable physical medium”, such as a flexible disk (FD), a CD-ROM, a DVD disk, a magneto-optic disk, an IC CARD, or the like that is to be inserted into the computer 300. Then, the computer 300 may read and execute the modular arrangement decision program 330a from the portable physical medium.

Furthermore, the modular arrangement decision program 330a is stored in “another computer (or a server)” or the like that is connected to the computer 300 through a public circuit, the Internet, a LAN, a WAN, or the like. Then, the computer 300 may read the modular arrangement decision program 330a from the other computer or the server device and execute the program.

According to an aspect of an embodiment of the present invention, an advantage is provided in that which module is arranged in which node.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A modular arrangement decision device comprising:
a storing unit that stores therein network information indicating a network to which multiple nodes each of which sends a detected event or relays the event are connected and that stores therein an identifier for identifying a module that performs a process on the event;
a first selecting unit that selects a predetermined number of pieces of information with a higher degree of evaluation from among pieces of first information and pieces of second information, on a basis of an evaluation value that indicates a degree of evaluation of the pieces of the first information and the pieces of the second information, the first information indicating a node in which the module is to be arranged among the multiple nodes, and the second information being obtained by changing the node in which the module is to be arranged from the first information;
a second selecting unit that selects a predetermined number of pieces of information with a smaller number of unmatched conditions among a predetermined number of conditions, from among the pieces of information selected by the first selecting unit and pieces of third information obtained by changing a node in which a module is to be arranged from the pieces of information selected by the first selecting unit;
a third selecting unit that selects, on the basis of an evaluation value that indicates a degree of evaluation of the pieces of information selected by the second selecting unit and pieces of fourth information obtained by changing a node in which a module is to be arranged from the information selected by the second selecting unit, and on the basis of a number of unmatched conditions among the predetermined number of the conditions in the pieces of information selected by the second selecting unit and the fourth information, information in which the evaluation value and the number of unmatched conditions satisfy a predetermined criteria from among the pieces of the information selected by the second selecting unit and the fourth information; and
an output unit that outputs the information selected by the third selecting unit.

2. The modular arrangement decision device according to claim 1, wherein
the second selecting unit creates the third information by changing, at a predetermined probability, a node in which a module is arranged from the information selected by the first selecting unit, the module being located upstream in a flow direction of the event in a process flow indicated by the module,
the third selecting unit creates the fourth information by changing, at the predetermined probability, a node in which a module is arranged from the information selected by the second selecting unit, the module being located upstream in the flow direction of the event in the process flow indicated by the module, and
the first selecting unit creates the second information by changing, at a probability higher than the predetermined probability, a node in which a module is arranged from the first information, the module being located upstream in the flow direction of the event in the process flow indicated by the module.

3. The modular arrangement decision device according to claim 1, wherein
the first selecting unit
creates new first information by changing the node in which the module is to be arranged from the information selected by the third selecting unit every time the information is selected by the third selecting unit, until the first selecting unit creates a predetermined number of pieces of the new first information,
creates new second information by changing the node in which the module is to be arranged from the new first information, and
selects a predetermined number of pieces of information with a higher degree of evaluation from among the new first information and the new second information, on the basis of the evaluation value of each pieces of the new first information and the new second information,
the second selecting unit
creates new third information by changing the node in which the module is to be arranged from the new information selected by the first selecting unit, every time information is newly selected by the first selecting unit, and
selects a predetermined number of pieces information with a smaller number of unmatched conditions among the predetermined number of the conditions from among the information selected by the first selecting unit and the new third information, and
the third selecting unit
creates, every time information is newly selected by the second selecting unit, new fourth information by changing the node in which the module is to be arranged from the information newly selected by the second selecting unit and
selects information in which the evaluation value and the number of unmatched conditions satisfy a predetermined criteria, from among the information newly selected by the second selecting unit and the new fourth information.

4. The modular arrangement decision device according to claim 1, wherein the second selecting unit calculates a weighted value of the unmatched conditions as the number of the unmatched condition, by using a weight corresponding to a type of the unmatched conditions.

5. The modular arrangement decision device according to claim 1, wherein
the first selecting unit creates the second information as a next generation by using a genetic algorithm when the first information is used as a parental generation,
the second selecting unit creates the third information as a next generation by using the genetic algorithm when the information selected by the first selecting unit is used as a parental generation, and
the third selecting unit creates the fourth information as a next generation by using the genetic algorithm when the information selected by the second selecting unit is used as a parental generation.

6. A modular arrangement decision system comprising:
multiple nodes; and
an information processing apparatus, wherein
each of the multiple nodes includes a control unit that sends a detected event or relays the event, and
the information processing apparatus includes
a storing unit that stores therein network information indicating a network to which the multiple nodes are connected and that stores therein an identifier for identifying a module that performs a process on the event,
a first selecting unit that selects a predetermined number of pieces of information with a higher degree of evaluation from among pieces of first information and pieces of second information, on a basis of an evaluation value that indicates a degree of evaluation of the pieces of the first information and the pieces of the second information, the first information indicating a node in which the module is to be arranged among the multiple nodes, and the second information being obtained by changing the node in which the module is to be arranged from the first information,
a second selecting unit that selects a predetermined number of pieces of information with a smaller number of unmatched conditions among a predetermined number of conditions, from among the pieces of information selected by the first selecting unit and pieces of third information obtained by changing a node in which a module is to be arranged from the pieces of information selected by the first selecting unit,
a third selecting unit that selects, on the basis of an evaluation value that indicates a degree of evaluation of the pieces of information selected by the second selecting unit and pieces of fourth information obtained by changing a node in which a module is to be arranged from the information selected by the second selecting unit, and on the basis of a number of unmatched conditions among the predetermined number of the conditions in the pieces of information selected by the second selecting unit and the fourth information, information in which the evaluation value and the number of unmatched conditions satisfy a predetermined criteria from among the pieces of the information selected by the second selecting unit and the fourth information, and
an output unit that outputs the information selected by the third selecting unit.

7. A modular arrangement decision method executed by a computer, the modular arrangement decision method comprising:
firstly selecting a predetermined number of pieces of information with a higher degree of evaluation from among pieces of first information and pieces of second information, on a basis of an evaluation value that indicates a degree of evaluation of the pieces of the first information and the pieces of the second information, the first information indicating a node in which a module is to be arranged among multiple nodes, and the second information being obtained by changing the node in which the module is to be arranged from the first information, and further on the basis of information stored in a storing unit, the information including network information indicating a network to which the multiple nodes each of which sends a detected event or relays the event are connected and an identifier for identifying a module that performs a process on the event;
secondly selecting a predetermined number of pieces of information with a smaller number of unmatched conditions among a predetermined number of conditions, from among the pieces of information selected in the firstly selecting and pieces of third information obtained by changing a node in which a module is to be arranged from the pieces of information selected in the firstly selecting; and
thirdly selecting, on the basis of an evaluation value that indicates the predetermined degree of evaluation of the pieces of information selected in the secondly selecting and pieces of fourth information obtained by changing a node in which a module is to be arranged from the information selected in the secondly selecting, and on the basis of a number of unmatched conditions among the predetermined number of the conditions in the pieces of information selected in the secondly selecting and the fourth information, information in which the evaluation value and the number of unmatched conditions satisfy a predetermined criteria from among the pieces of the information selected in the second selecting and the fourth information.
